(19) United States
(12) Patent Application Publication
(10) Pub. No.: US 2005/0269406 A1
(43) Pub. Date: Dec. 8, 2005

(54) Cryptographic systems and methods, including practical high certainty intent verification, such as for encrypted votes in an electronic election

(76) Inventor: C. Andrew Neff, Bellevue, WA (US)

Correspondence Address: PERKINS COIE LLP;PATENT-SEA, P.O. BOX 1247, SEATTLE, WA, 98111-1247, US

(21) Appl. No.: 11/147,655

(22) Filed: Jun. 7, 2005

Related U.S. Application Data
(63) Continuation-in-part of application No. 10/944,433, filed on Sep. 17, 2004.
(60) Provisional application No. 60/577,566, filed on Jun. 7, 2004.
(60) Provisional application No. 60/579,894, filed on Jun. 15, 2004.
(60) Provisional application No. 60/682,792, filed on May 18, 2005.

(51) Int. Cl. G06F 17/60

(52) U.S. Cl. 235/386; 705/12

(57) ABSTRACT

Methods and associated systems provide proof of a ballot cast in an election or of user choices under a data structure. The method includes, for example, casting a ballot representing a voter's intended choice associated with a cast ballot, and creating a private, paper receipt that represents the voter's intended choice associated with the cast ballot. The private, paper receipt includes human-readable information to permit the voter to publicly verify that the cast ballot has been included in a ballot tabulation process, and wherein only the voter can discern from the human-readable information on the private, paper receipt what the voter's intended choice was, with respect to the cast ballot.

### CROSS-REFERENCE TO RELATED APPLICATIONS

This application claims the benefit of U.S. Provisional Patent Application Nos. 60/577,566 and 60/579,894, filed Jun. 7 and Jun. 15, 2004 (attorney docket numbers 32462-8011 US and -8011US1), respectively, both entitled “Practical High Certainty Intent Verification for Encrypted Votes,” and 60/682,792, filed May 18, 2005 “Cryptographic System and Method, Such as For Use in Verifying Intent of a Voter in an Electronic Election,” (attorney docket number 32462-8011 US2), all by the same inventor and assignee. This application also is a continuation-in-part U.S. patent application Ser. No. 10/944,433, filed Sep. 17, 2004, entitled “Detecting Malicious Poll Site Voting Clients” which claims the benefit of U.S. patent application Ser. No. 10/718,035, filed Nov. 20, 2003, and which claims the benefit of U.S. Provisional Patent Application No. 60/428,334, both entitled “Verifiable Poll-Site E-Voting,” and all by the same inventor and assignee (attorney docket numbers 32462-8010US2, -8010US1, and 8010US, respectively).

### BACKGROUND

Cryptographic election protocols have for many years endeavored to provide a purely information based procedure by which private (i.e. secret) voter choices (i.e. votes) can be publicly aggregated (i.e. tallied) subject to two requirements:
1. Every voter should be able to determine with high certainty that her choice (vote) has been accurately included in the final result, or tally, without any requirement for the voter to trust the behavior, action, or proper functioning of one or more election system components.
2. It should not be possible for any voter, by means of tangible evidence, to convince another individual, or party (technically referred to as the coercer), of the value of her choice (vote).

Intuitively, these two requirements seem mutually exclusive. Regarding the second criteria, there are technical limits to the degree that it can be achieved at all. For example, if the “other party” includes all other voters in the election, then the value of the voter's choice can be simply deduced by the coercer from the final tally, independent of any help from the voter. Nevertheless, under standard cryptographic assumptions, and reasonable assumptions about the extent of collusion achievable by the coercer, protocols have been proposed that, at least theoretically, successfully address these requirements simultaneously. Each of these schemes has some practical drawbacks though.

In “Receipt-Free Secret-Ballot Elections” by, J. Benaloh and D. Tuinstra, the first theoretical framework is described, but certain elements of how it is to be embodied in practice are left unspecified. In particular, each voter must leave the “booth” with a record of information to compare with the public tally. The assumption seems to be that voters will remember this information, but the amount of information is large enough that human memory is not a reasonable data recording device. Further, if one imagines that a receipt type printer is used instead for data recording, it would be important to “undo” the sequence in which information is presented in the booth. This probably means that the receipt printer must cut the receipt into several pieces before delivering it to the voter. Furthermore, the scheme is cumbersome in that it requires the voter to compare a large amount of data with data in the public tally.

The scheme described in “Secret-Ballot Receipts and Transparent Integrity: Better and less-costly electronic voting at poling places,” by D. Chaum, http://www.vreceipt.com/article.pdf, 2002, and elaborated upon in “A Dependability Anaysis of the Chaum Digital Voting Scheme,” by J. Bryans and P. Ryan, University of Newcastle upon Tyne Technical Report Series CS-TR-809, 2003, address several of the issues of the previous two schemes described above by using visual cryptography (See: M. Naor and A. Shamir, Visual Cryptoptograph. Advances in Cryptology—Eurocrypt 94, LNCS vol. 950, pp. 1-12. Springer-Verlag, Berlin, 1995). However, it also creates some issues of its own. First, as with the previous scheme, there is still a need to “destroy physical evidence” in order to prevent the threat of coercion. In this scheme, it is one of the two media layers on which the visual cryptography pieces of the scheme are printed or otherwise marked. Also, because multiple layers must be printed and exactly aligned, a printer with special capabilities is required. That is, it is not possible to use many standard and inexpensive printing devices. A third characteristic of the scheme is the fact that fraud can be detected by the voter with a probability of at best 1/2. In principle, this is not a big problem for attended (i.e. poll site) voting, but it does raise some practical concerns: A moderately large chance of undetected fraud means that voters must be able to protest when they detect a fraud event. The protest process may be cumbersome, and could result in a loss of ballot privacy. Moreover, protests may occasionally occur even if the voting device never misbehaves, since some voters are likely to make mistakes and confuse their own error with device misbehavior. Additionally, a 1/2 chance of undetected fraud is insufficient, even in principle, for remote voting applications where election officials are not available to resolve disputes between voter and device. Furthermore, a fourth characteristic of the scheme may present a significant usability problem. The receipt data that must be compared against the public election tally is a set of pixels. In order to handle typical sized ballots, these pixels will be quite small. The assumption that voters will be able to visually compare this data is problematic.

### BRIEF DESCRIPTION OF THE DRAWINGS

FIG. 1 is a block diagram of a suitable computing system in which aspects of the invention may be employed.

FIG. 2 is a flow diagram of an example of a data communication protocol performed by a voting computer or device and associated elements.

FIG. 3 is data flow diagram showing data flow after display of a ballot.

FIG. 4 is a block diagram illustrating a one way communication system for communicating data from a voting device or computer to a printer or other output device for use in voting.

FIG. 5 is a block diagram of an intermediate device between the voting device and printer for selectively disconnecting the printer from the voting device, and which includes a user input portion, such as a keypad.

FIGS. 6A and 6B together are a flow diagram illustrating a series of information/instruction display screens and receipt generation under an alternative voting protocol that may employ the devices of FIG. 4 or 5.

FIGS. 7A through 7I are diagrams illustrating a series of display screens providing information and instructions to a voter under a voting protocol, and generation of a voting receipt under such protocol.

FIG. 8 is a flow diagram illustrating an alternative voting protocol that employs secret codebooks or dictionaries.

The headings provided herein are for convenience only and do not necessarily affect the scope or meaning of the claimed invention.

### DETAILED DESCRIPTION

Presented below is a verification scheme that overcomes the drawbacks of the schemes mentioned above, and which provides additional benefits. In particular, this scheme may be employed in an electronic voting context, and is a practical, coercion free, secret vote receipt scheme that does not produce some piece of physical evidence which must be destroyed immediately after each voter casts a ballot. It also provides a way for the voter to detect error or ballot fraud by the voting device with very high probability.

In particular, a universally verifiable, cryptographic vote casting protocol is described that enables each voter to determine with high certainty via a receipt that her choices (intended votes) have been accurately represented in the input to a public tally. However, since the receipt, in isolation, can represent a choice for any candidate with equal probability, it does not enable vote buying or coercion. The information that the voter uses to convince herself of encrypted ballot integrity includes temporal information that is only available at the time the ballot is cast. As with conventional voting systems, the act of casting takes place in a private environment—i.e. the “poll booth.” Under this assumption then, the scheme, in conjunction with a universally verifiable tabulation protocol, provides an end-to-end verifiable, secret vote receipt based election protocol that is coercion free.

Intrinsically, the protocol is unconditionally secure, although for the sake of usability, the commitment of data is likely to be implemented via a secure one-way hash. The security of such an implementation would then depend on the one-way property of the hash function employed. The scheme requires no more computation or data processing from the voter than that which is performed by a bank customer at a typical ATM. Thus, it is very practical.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Suitable Computing System

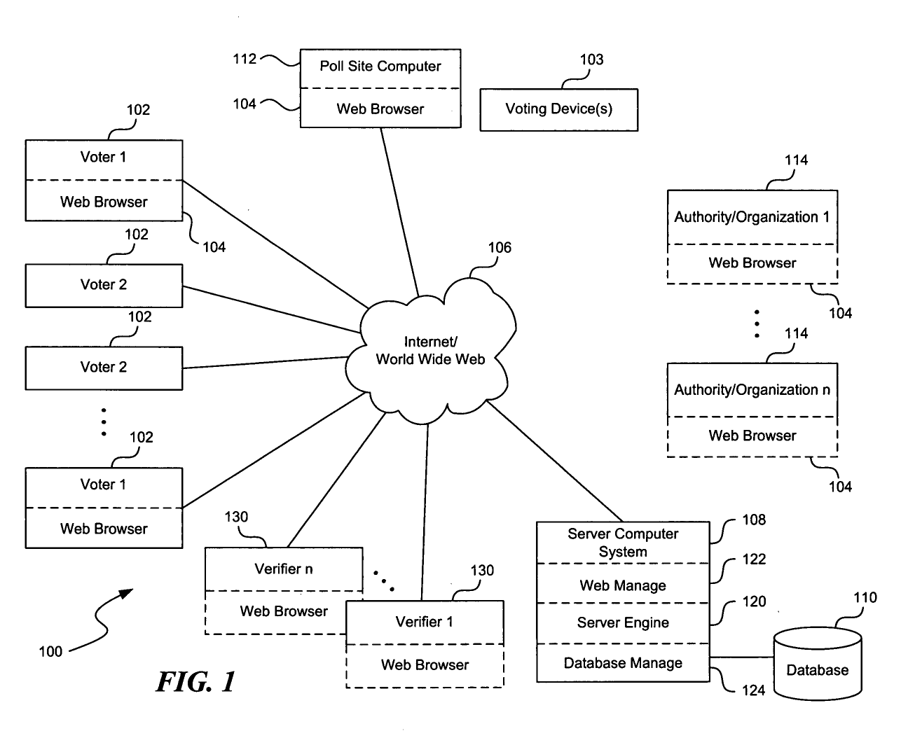

FIG. 1 and the following discussion provide a brief, general description of a suitable computing environment in which aspects of the invention can be implemented. Although not required, embodiments of the invention may be implemented as computer-executable instructions, such as routines executed by a general-purpose computer, such as a personal computer or web server. Those skilled in the relevant art will appreciate that aspects of the invention (such as small elections) can be practiced with other computer system configurations, including Internet appliances, hand-held devices, wearable computers, personal digital assistants (“PDAs”), multiprocessor systems, microprocessor-based or programmable consumer electronics, network PCs, mini computers, cell or mobile phones, set-top boxes, mainframe computers, and the like. Aspects of the invention can be embodied in a special purpose computer or data processor that is specifically programmed, configured or constructed to perform one or more of the computer-executable instructions explained herein. Indeed, the term “computer,” as generally used herein, refers to any of the above devices, as well as any data processor.

Aspect of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules or sub-routines may be located in both local and remote memory storage devices. Aspects of the invention described herein may be stored or distributed on computer-readable media, including magnetic and optically readable and removable computer disks, stored as firmware in chips, as well as distributed electronically over the Internet or other networks (including wireless networks). Those skilled in the relevant art will recognize that portions of the protocols described herein may reside on a server computer, while corresponding portions reside on client computers. Data structures and transmission of data particular to such protocols are also encompassed within the scope of the invention.

Unless described otherwise, the construction and operation of the various blocks shown in FIG. 1 are of conventional design. As a result, such blocks need not be described in further detail herein, as they will be readily understood by those skilled in the relevant art.

Referring to FIG. 1, a suitable environment of system 100 includes one or more voter or client computers 102, some of which may include a browser program module 104 that permits the computer to access and exchange data with the Internet, including web sites within the World Wide Web portion 106 of the Internet. Possibly more importantly, embodiments of the invention described below may employ a voting computer or voting device 103 that is stand-alone and not connected to any network. (As explained below, the voter may check a final ballot tally via the voter computer 102 over the internet 106 after voting.) The voter computers 102 and voting device computer 103 may include one or more central processing units or other logic processing circuitry, memory, input devices (e.g., keyboards, microphones, touch screens, and pointing devices), output devices (e.g., display devices, audio speakers, and printers), and storage devices (e.g., fixed, floppy, and optical disk drives, memory/smart card readers/writers), all well known but not shown in FIG. 1. As shown in FIG. 1, there are N number of voter computers 102, representing voters 1, 2, 3 . . . N, and while only one voting device 103 is shown, more than one voting device may be employed at any given poll site.

A server computer system 108 or “vote collection center,” coupled to the Internet or World Wide Web (“Web”) 106, performs much or all of the final ballot collection, storing and other processes. (Needless to say, various other electronic devices “in the field” are also likely to be used for transitory ballot collection and storing processes, much as paper ballots are collected in batches at individual poll sites before being transported to a central counting location.) A database 110, coupled to the server computer 108, stores much of the data (including ballots) from the voter computers 102, and the one or more voting device computers 103.

One or more poll site logistic computers or voting poll computers 112 are personal computers, server computers, mini-computers, or the like, that may be positioned at a public voting location to permit members of the public to electronically vote under the system described herein. Thus, the voter computers 102 may be positioned at individual voter's homes, where one or more poll site logistics and voting device computers 112 and 103 are located publicly or otherwise accessible to voters in a public election. The poll site logistics computers 112 include a printer or other suitable output device (such as a recording drive for recording data on a removable storage medium), and may include a local area network (LAN) having one server computer and several client computers or voter terminals coupled thereto via the LAN.

Overall, embodiments of the invention may be employed by a stand-alone voting device 103 located within the privacy of a poll booth at a poll site, as well as by remote voter computers 102 located within individual voter's homes. (When performed by the remote voting computers 102, embodiments of the invention still provide private receipts and full verification, and may deter coercion, but may suffer from a third party looking over the shoulder of the voter (thus lacking the privacy of a poll booth), and may lack certain hardware features, such as a printer screen, to indicate to the voter that the voting computer has printed a commitment without the voter seeing it, as described below.) Without network connectivity, the voting devices 103 can locally store electronically cast ballots, which may then be provided to the poll site computer 112 via a wire-to-wireless connection, or physical transport of data storage media to the poll site computer, such as when the polls close. In general (unless described below), the voting devices 103 and voter computers 102 need only provide a one-way transmission of electronic ballots during voting (although the voting computer 102 may need to receive information regarding cast ballots to confirm that a ballot had been properly cast and included in the tally by accessing a public bulletin board, described below). Note also that the term “voter” is generally used herein to refer to any individual or organization that employs some or all of the protocols described herein.

Under an alternative embodiment, the system 100 may be used in the context of a private election, such as the election of corporate officers or board members. Under this embodiment, the voter computers 102 may be laptops or desktop computers of shareholders, and the voting device 103 poll site computer 112 can be one or more computers positioned within the company (e.g., in the lobby) performing the election. Thus, shareholders may visit the company to access the voting device 103 to cast their votes.

One or more authority or organization computers 114 are also coupled to the server computer system 108 via the Internet 106. If a threshold cryptosystem is employed, then the authority computers 114 each hold a key share necessary to decrypt the electronic ballots stored in the database 110. Threshold cryptographic systems require that a subset t of the total number of authorities n (i.e., t<n) agree to decrypt the ballots, to thereby avoid the requirement that all authorities are needed for ballot decryption. In other words, the objective of a threshold cryptosystem is to share a private key, s, among n members of a group such that messages can be decrypted when a substantial subset, T, cooperate—a (t, n) threshold cryptosystem. Protocols are defined to (1) generate keys jointly among the group, and (2) decrypt messages without reconstructing the private key. The authority computers 114 may provide their decryption shares (typically one per Authority per voted ballot) to the server computer system 108 after the voting period ends so that the server computer system may decrypt the ballots and tally the results.

One or more optional verifier computers 130 may also be provided, similar to the authority computers 114. The verifier computers may receive election transcripts to verify that the election has not been compromised. For example, the verifier computers may receive electronic validity proofs from each of the authority computers. The verifier computers may perform verifications after the election, and need not be connected to the Internet. Indeed, the verifications may be performed by other computers shown or described herein. The authority and verifier computers 114 and 130 may likely deal with every large amounts of numerical or character data over a network (such as the internet). As a result, while web browsers are shown, such computers may alternatively employ a client/server-type application.

The server, voting poll, verifier or authority computers may perform voter registration protocols, or separate registration computers may be provided (not shown). Such registration computers may include biometric readers for reading biometric data of registrants, such as fingerprint data, voice fingerprint data, digital picture comparison, and other techniques known by those skilled in the relevant art. Details on a suitable cryptographic protocol may be found in U.S. patent application Ser. No. 10/484,931, entitled VERIFIABLE SECRET SHUFFLES AND THEIR APPLICATION TO ELECTRONIC VOTING (attorney docket number 32462-8002US7), while details on a suitable registration process may be found in U.S. patent application Ser. No. 09/534,836, entitled METHOD, ARTICLE AND APPARATUS FOR REGISTERING REGISTRANTS, SUCH AS VOTER REGISTRANTS (attorney docket number 32462-8004US), both by the same inventor and assignee.

The server computer 108 includes a server engine 120, an optional web page management component 122, a database management component 124, as well as other components not shown. The server engine 120 performs, in addition to standard functionality, portions of an electronic voting protocol. The encryption protocol may be stored on the server computer, and portions of such protocol also stored on the client computers, together with appropriate constants. Indeed, the above protocol may be stored and distributed on computer readable media, including magnetic and optically readable and removable computer disks, microcode stored on semiconductor chips (e.g., EEPROM), as well as distributed electronically over the Internet or other networks. Those skilled in the relevant art will recognize that portions of the protocol reside on the server computer, while corresponding portions reside on the client computer. Data structures and transmission of data particular to the above protocol are also encompassed within the present invention.

The server computer 120 collects electronic ballots or tallies and posts them for external review and access by, for example, the voter computers 102, as in a “public bulletin board” described below. The server computer may furthermore manage communication between various election participants, as well as archived data. In an alternative embodiment, the server engine 120 may perform ballot transmission to authorized voters or poll sites, ballot collection, verifying ballots (e.g., checking digital signatures and passing verification of included proofs of validity in ballots), vote aggregation, ballot decryption and/or vote tabulation. The electronic ballots are then stored and provided to a third party organization conducting the election, such as a municipality, together with tools to shuffle ballots, decrypt the tally and produce election results. Likewise, election audit information, such as shuffle validity proofs and the like may be stored locally or provided to a municipality or other organization.

The optional web page component 122 handles creation and display or routing of web pages such as an electronic ballot box web page. For example, voters and users may access the server computer 108 by means of a URL associated therewith, such as http:\\www.votehere.net, or a URL associated with the election, such as a URL for a municipality. The municipality may host or operate the server computer system 108 directly, or automatically forward such received electronic ballots to a third party vote authorizer who may operate the server computer system. The URL, or any link or address noted herein, can be any resource locator.

The election scheme and system may use a “bulletin board” where each posting is digitally signed and nothing can be erased. The bulletin board is implemented as a web server. The “ballot box” resides on the bulletin board and holds all of the encrypted ballots. The risk of erasure can be effectively mitigated by writing the web server data to a write-once, read-many (WORM) permanent storage medium or similar device.

Note that while one embodiment of the invention is described herein as employing the Internet to connect computers, other alternative embodiments are possible. For example, aspects of the invention may be employed by stand alone computers (like the voting device 103). Aspects of the invention may also be employed by any interconnected data processing machines. Rather than employing a browser, such machines may employ client software for implementing aspects of the methods or protocols described herein. Further, data can always be communicated by physical transport of storage media from one location to another.

Suitable Electronic Voting Model

Aspects of the invention are described with respect to a simple model, which reflects current poll site voting practice. (Later, a relaxation of this model will be described which reflects a remote, i.e. “vote from home,” scenario.) Three primary participants in the model (scheme) are a Voter, V, a Voting Device, D, and a Printer, P. These “participants” communicate information between each other, and all such communication consists of strings of characters from an arbitrary, but pre-established alphabet. (For example, numbers, letters, and/or icons or other glyphs.)

A fourth entity, C—the Coercer. C does not explicitly participate in the model, and in practice may not be present at all. However, a property of a protocol under the model that is described in detail below is its coercion resistance: even if V cooperates with C, V can not prove the value of its vote choice to C by way of all the available election data, as long as all steps of the protocol are conducted in an environment that can not be observed—either directly or indirectly—by C. In practice, the voting booth provides this environment.

Finally, as noted above, there are other entities which are standard elements of all universally verifiable election protocols: a set of Election Authorities, A₁, . . . , Aₙ (where n≧1 is a public election parameter), and a “Bulletin Board,” BB, which represents some accepted mechanism for publishing data to all election participants.

The characteristics of each of the primary participants are as follows:
Voter The Voter, V, is capable of both reading from, and writing to D. Typically, reading is done via a CRT, or touch-screen display, and writing is done via a keyboard, and/or mouse, and/or touch-screen display. The form of the data to be read and written is very simple—short character strings (typically 2-4 characters long depending on the alphabet chosen). V is also capable of reading from P, but may or may not be not capable of writing to P.
Voting Device The Voting Device, D, is capable of writing to both V and P. The act of “writing to V” simply means showing information on the CRT, or touch-screen display for V to view. Any computing device may be employed, including those noted herein (such as the voter computer 102, as noted below). The act of writing an information string, or message, m, to P means that P outputs, or displays, m, on its media. (This media is usually, but not necessarily, a sheet, or tape, of paper). Thus, the model may ignore hardware level communication subtleties that may take place in a physical embodiment of the model.
   D is also capable of reading from (i.e. taking input from) V, typically via a keyboard, mouse, or touch-screen display.
   It is not assumed that D can read from (i.e. receive information from) P, however, whether or not it can is not important to the verification properties of the protocol. That is, V need not be certain that P can not communicate back to D in order to derive desired confidence from successful execution of the protocol.
   Further, a bit stream, [symbol] is read only by D. One may assume that C can not distinguish [symbol] from a random bit stream. Any full voting system embodiment of the protocol will need to assure this “Random Number Generator” property by a combination of procedures, policy and other audit mechanisms, since in practice it could be possible for C to gain knowledge about, or control [symbol] by some means external to the protocol. However, note that:
      1. This property is relevant to any universally verifiable, secret ballot election protocol, regardless of the voter verification protocol employed: If, for example, C can control [symbol] , C can simply read V's vote choices from the public election tally by decrypting. So, in such circumstances, whether or not a receipt is present is inconsequential.
      2. Whether or not an embodiment is successful at assuring this property does not impact election results integrity. That is, neither V's assurance of encrypted ballot correctness, nor the public assurance of encrypted tally correctness is impacted by the degree of randomness provided by [symbol] .
Printer The Printer, P, is effectively embodied by a generic receipt tape (“cash register”) printer, although any other printer or similar device may be employed, or other output device, including those noted herein (not shown in FIG. 1). It is capable of “showing” (e.g. printing) information that it receives from D (which can then be read by V).
   For vote verification (i.e. V can detect if D has cast a ballot inconsistent with V's intent), assumptions about P are:
      1. V can inspect its output (i.e. the printer tape isn't somehow permanently hidden from V).
      2. P is not capable of erasing, changing, or otherwise overwriting information that has already been “shown” (i.e. printed) without immediate detection by V.
   Both of these properties are nearly unavoidable for most, if not all, standard printing devices and technologies in any reasonable configuration, and thus any such printing device with these properties a may be referred to as a “generic printer”.
   In order to prevent coercion, P is capable of committing a short string, s, of characters to V without revealing any information about the actual value of s. One simple way to achieve this with a standard receipt tape printer, is to attach a “shield” that partially obscures the paper at the printer's tape exit. In order to commit s, P can print a line that contains some alignment marks, and s positioned so that the alignment marks are visible to V, but s is not. After some further steps, P can easily reveal s to V by scrolling its tape past the “shield.” Many variations on this configuration are possible. In fact, some standard receipt printers have their print head positioned so far from their tape exit that they may support such a commit action without modification.””
   This last assumption does impose a physical security constraint on the system, though one that is easy to realize in practice. For example, in the configuration suggested above, the voter should be prevented from removing the shield, or pulling the paper tape out prematurely.

Notation

For standard cryptographic election terms and parameters, the following discussion employs the notation of “A secure and optimally efficient multi-authority election scheme” by R. Cramer, R. Gennaro, B. Schoenmakers, from Advances in Cryptology—EUROCRYPT '97, Lecture Notes in Computer Science, Springer-Verlag, 1997. In order to simplify the presentation, an election below consists of a single question, or issue, Q, which offers n candidates (or choice options) whose identifiers are C₁, . . . , Cₙ from which each voter can select one, and that for the sake of tabulation, the candidate identifiers receive a publicly known fixed order. This order will be easily derived from the election's official “blank ballot” (sometimes known as “ballot style”), though it does not mean that the candidates must be displayed in this order during the ballot casting process. Abstentions can be handled by adding an explicit “ABSTAIN” candidate. The generalization to multi-question (or multi-issue) ballots, and to questions that allow for voters to choose multiple candidates will be obvious to those skilled in the relevant art to.

The following summarizes the additional notation used throughout.
M The message space. This is the set of bit strings, m, that can be encrypted by an encryption function, E. For example, using the standard ElGamal encryption scheme, M= [symbol] g [symbol] , a cyclic subgroup of Zₚ* generated by some fixed g∈Zₚ*.
Ω The encryption seed space. The space (set) of strings, or elements that are used to generate encryptions of a message m∈M. For example, using the standard ElGamal encryption scheme, Ω={0≦ω<q} for some large prime factor q of p−1, and the encryption of a message m by seed ω is the ElGamal pair (g^{ω},h^{ω}m).
E The encryption function. In the standard ElGamal scheme, E (m,ω)=(g^{ω},h^{ω}m).
Y A unique, fixed, “yes” message, Y∈M, which is a publicly known parameter of the scheme (as are g and h, the election encryption parameters). In the standard ElGamal scheme, one choice for Y would be Y=G, for some arbitrary, fixed, and publicly known G∈ [symbol] g [symbol] .
N A unique, fixed, “no” message, N∈M, which is a publicly known parameter of the scheme. In the standard ElGamal scheme, one choice for N would be N=1.
T The encrypted message inversion function. T has the following properties:
   Tf1. ∀ω∈Ω, T(E(Y,ω))=E(N,θ) for some θ∈Ω.
   Tf2. ∀ω∈Ω, T(E(N,ω))=E(Y,θ) for some θ∈Ω.
   Tf3. ∀ω∈Ω, if m∉{Y,N} then T(E(Y,ω))=E(\overline{m},θ) for some θ∈Ω and \overline{m}∉{Y,N}.

In the standard ElGamal scheme, T((X,Y))=(X⁻¹,GY⁻¹).
Γ The encoding alphabet. A publicly known, ordered set of characters (i.e. symbols, marks, or glyphs). For example, the standard HEX alphabet is [0, 1, 2, . . . , 9, A, B, . . . , F].
e The encoding function. A publicly known, 1-1 function from bit strings ({0,1}*) to strings of characters from Γ(Γ*). (Both e and e⁻¹ need to be “easily computable.”) In practice, e is simply taken to be the counting function using lexicographical order. For example, if Γ is the HEX alphabet, e(11010)=1A.
L The size of a challenge space (see below). L can be thought of as a “verification security parameter.” It is a “moderate sized” positive integer (e.g. 1≦L≈2¹⁰−−2¹⁵), which is a public election parameter along with quantities such as the encryption moduli, p and q.
Λ The challenge space. Λ is a publicly known subset of Γ* of size L. Typically, Λ will consist of the first L strings in Λ* taken in lexicographical order. Note that if the size of Γ is between 2⁴ and 2⁶ (standard HEX, etc.), then the number of characters that are needed to represent an element of Λ will be between 2 and 4—about the length of a bank ATM PIN.
P:x∈_{R}S Participant, P, randomly selects an element x from set S. P will typically be V or D. (When P is D, this means that D will choose x by taking bits from [symbol] as needed.) Truly random selection is a stronger requirement than often needed in practice. The selection need only be “sufficiently unpredictable.”

$${P}_{1} {←}^{ x } {P}_{2}$$

Participant, P₁ “reads” (i.e. gets, or sees) x from participant P₂. (In other words, participant P₂ “writes” (i.e. shows) x to participant P₁.) Typically, P₂ is either V or D, and P₁ is V, D, or P. Typically, x will be a string over Γ (i.e. x∈Γ*). A typical mechanism for read/write communication are described above.
[symbol] [symbol] x₁; . . . ; xₖ [symbol] [symbol] A string sequence encoding. If the xᵢ characters from some alphabet, A, [symbol] [symbol] x₁; . . . ; xₖ [symbol] [symbol] is a string representing a sequence of individual strings. One way to define such an encoding is to let [symbol] [symbol] x₁; . . . ; xₖ [symbol] [symbol] =x₁‘+’ . . . ‘+’xₖ where ‘+’ is some special separator character or symbol not in A. (It could be a tab, or white space character.) Conceptually, it is useful to think that whenever P shows (i.e. prints) [symbol] [symbol] x₁; . . . ; xₖ [symbol] [symbol] it does so on a line all by itself—although there are certainly other ways to achieve the goal of setting it off from other characters.

Suitable Protocol

A suitable protocol may be presented in two stages. First, a communication level view of the protocol is presented that indicates a sequence of data exchanged between participants. With this in mind, it will then be easier to present a mathematical level structure for the protocol.

Communication View

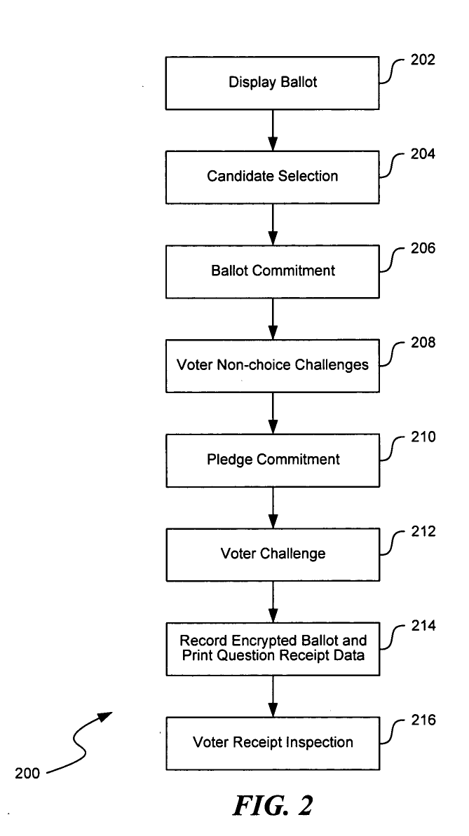

FIG. 2 provides an example of a communication view of data elements exchanged, namely a process 200. Beginning in block 202, the device D displays a ballot whereby:
1. For 1≦i≦n, D:pᵢ∈_{R}Λ.
2.

$$V {←}^{〈 〈 Q ; {C}_{1} ; … ; {C}_{n} 〉 〉} D .$$

Under block 204, the voter V selects a candidate, wherein:
1. V selects intended choice, Cᵢ, where 1≦i≦n.
2.

$$D {←}^{〈 〈 {C}_{1} 〉 〉} V .$$

(That is, V communicates to D its candidate choice.) (Note that processes under blocks 202 and 204 are identical to those followed by typical direct recording equipment (DRE).)

Under block 206, the device D makes a ballot commitment, wherein:
1. For each 1≦j≦n, D computes xⱼ∈_{R}Λ.
2. D computes a verifiable ballot commitment, H “consistent with” {xⱼ}ⱼ₌₁ⁿ (as explained below).
3.

$$P {←}^{H} D$$

(Effectively, H is V's encrypted voted ballot itself, or, for the sake of convenience, a one-way hash of it. In practice, H would be surrounded by easily identifiable “BEGIN” and “END” strings, much like the strings used to surround PgP encrypted messages under the publicly available encryption applications by PGP Corp. of Palo Alto, Calif.)

Under block 208, the voter V provides “unchoice” challenges to D, wherein:
1. For each 1≦j≠i≦n, V selects cⱼ∈Λ∪Υ as desired. The cⱼ are not true challenges, but are available to V in order to prevent coercion (as explained below).
2.

$$D {←}^{〈 〈 {c}_{1} ; … ; {c}_{i - 1} ; {c}_{i + 1} ; {c}_{n} 〉 〉} V .$$

(That is, V communicates the sequence {cⱼ}_{j≠i} to D.)
3. [Optional] For each cⱼ=Υ, D:cⱼ∈_{R}Λ. That is, D “randomly fills in” the cⱼ V does not care about. (Alternatively, V may be required to explicitly choose all cⱼ.)

Under block 210, the device D and printer P make a pledge commitment, wherein:
1. For each 1≦j≦n, D computes pⱼ according to
   pⱼ=e⁻¹(e(cⱼ)⊕e(xⱼ))j≠i
   pᵢ=xᵢ
where ⊕ is bitwise XOR.
2. P commits the sequence {pⱼ}ⱼ₌₁ⁿ (or a 1-way hash of it) as discussed above. This means that V can tell that D has committed to this particular sequence of pⱼ on a receipt tape or other printable substrate, but V has no knowledge of the specific values of the pⱼ. (Again, this property is not necessary for vote verification, only for coercion prevention.)

Under block 212, the voter V and device D perform a voter challenge, wherein:
1. V:c∈_{R}Λ.
2.

$$D {\underline{←}}^{ c } V .$$

(That is, V communicates c to D.)

Under block 214, the device D, records an encrypted ballot and prints question receipt data, wherein:
1. D sets cᵢ=c.
2. For 1≦j≦n,

$$P {←}^{〈 〈 {C}_{j} ; {c}_{j} 〉 〉} D .$$
3.

$$BB {←}^{ {B}_{v }} D .$$

That is, D posts V's encrypted voted ballot, Bᵥ (format to be described below), to BB. (In practice, this is likely to be achieved by having D write Bᵥ to a local storage medium so that it can be transported and/or copied to BB soon after the poll site closes.)

Under block 216, the voter V may perform inspection of the voter receipt, wherein:
V accepts the protocol execution if and only if
1. V observed H fully printed before continuing to the Voter Challenge step.
2. The printer (receipt) display of c is accurate. That is, P prints c on the “candidate Cᵢ line.”
3. (For prevention of coercion only) V is “satisfied” with the printed lines corresponding to Cⱼ for j ≠i—that is, for those j that V cared to choose a string, cⱼ, that same string is printed on the Cⱼ line. The values of the data on these lines do not impact the level of certainty that V has as to the correctness of its (cast) encrypted ballot. These lines are present purely to thwart coercion.

The steps described above are executed in the privacy of the poll booth. In order for V to check that his or her intended choice has been properly included in the public tally, V may also compare the contents of the receipt against the contents of BB. This compare operation is simple—in fact, it can be carried out by inspection. This is because the receipt data can be derived from Bᵥ by a well defined, public computation. V need only check that its receipt data matches the corresponding BB data character for character. Further, the total number of characters to be compared is relatively small, and can be carried out by anyone—V's chosen proxy, for example—without having to know the value of V's candidate choice.

Structural Details

Merely exchanging data as described in the previous subsection does not provide any level of certainty to V that its encrypted ballot has been formed as V intended. Certainty is derived from the connection between the exchanged data and the underlying tabulatable data. This connection can be publicly verified as explained below.

Structural Overview

At a high level, the connection between receipt data exchanged in the poll booth and tabulatable data that will be input to a verifiable electronic election such as a shuffle or mix-net electronic election protocol can be described as follows:
1. The “opened verifiable choice” (the voted ballot—defined below), Bᵥ, that D posts to BB is “verifiably linked” to the ballot commitment, H. That is, it can be publicly verified that Bᵥ is the encrypted choice corresponding to H.
2. A public transformation, M is applied to Bᵥ producing three outputs, an ordered sequence {\overline{p}ⱼ}ⱼ₌₁ⁿ and ordered sequence {\overline{c}ⱼ}ⱼ₌₁ⁿ, and V's encrypted choice, Iᵥ, which is the input to tabulation.
3. If Iᵥ is “well formed” according to a publicly known specification, and if it represents a vote for a candidate, Cⱼ, different from the candidate chosen by V (recall that V chose candidate Cᵢ, so this means j≠i), then there is only one value of c=cᵢ for which the output value \overline{p}ᵢ is equal to the value pᵢ committed by D in the poll booth. Since V has an authenticated copy of pᵢ and cᵢ, if V selected c randomly in the poll booth (which means from the uniform distribution on Λ, but in practice the distribution can be somewhat skewed), the probability that Iᵥ is both “well formed” and undetectably represents a choice for “the wrong candidate” (a candidate different from the one chosen by V) is 1/L.
4. If Iᵥ is not “well formed,” then it will, with certainty, produce an invalid decryption at the output of the verifiable mix-net tabulation. The mixers or shufflers, if required, can cooperate to find the specific input, or inputs, that are not well formed. Alternatively, the protocol can be trivially augmented to require that D post a ballot validity proof to BB at the same time that Bᵥ is posted (see, e.g., R. Cramer, R. Gennaro, B. Schoenmakers, “A secure and optimally efficient multi-authority election scheme,” Advances in Cryptology—EUROCRYPT '97, Lecture Notes in Computer Science, Springer-Verlag, 1997). This would allow each voter, V, to verify that its Iᵥ is well formed independently and before election tabulation.

Putting these properties together, as long as D can not predict V's choice of c with probability significantly greater than 1/L, the chance that V's intent has been undetectably miscounted in the public tally is 1/L.

Protocol Data Structures

A version of the protocol is now presented that is simple conceptually; optimizations are discussed below. In this protocol version, L=2^{l} for some positive integer l.

Definition 1. A ballot mark pair (BMP) is an ordered pair of encryptions, φ=(E₁,E₂)=(e(m₁,ω₁), e(m₂,ω₂)). A valid BMP is a BMP with the property that both m₁∈{Y,N} and m₂∈{Y, N}.

Definition 2. Let x be the “type” function which takes a BMP as argument, takes values in the set {−1,0,1}, and is defined by

$$X ( ϕ ) = \{ \begin{matrix}1 & if ϕ is valid and {m}_{1} = {m}_{2} \\ 0 & if ϕ is valid and {m}_{1} \neq {m}_{2} \\ - 1 & if ϕ is not valid .\end{matrix} \qquad ( 1 )$$

Definition 3. A candidate mark (CM) is an ordered sequence of l BMPs.

The notion of “type” to CMs may be extended as follows:

Definition 4. Let τ be the function which takes a CM, Φ=(φ₁, . . . , φₗ), as argument, takes values in the set {−1,0,1}, and is defined by

$$τ ( Φ ) = \{ \begin{matrix}1 & if χ ( {ϕ}_{i} ) = 1 ∀ 1 \leq i \leq l \\ 0 & if χ ( {ϕ}_{i} ) = 0 ∀ 1 \leq i \leq l \\ - 1 & otherwise\end{matrix} \qquad ( 2 )$$

Definition 5. A CM, Φ, is valid if τ(Φ)∈{0,1}. It is invalid if τ(Φ)=−1 (i.e. otherwise).

The voter's encrypted choice will be represented by three different, but closely related data structures. These are a verifiable choice (VC), opened verifiable choice (OVC), and tabulation input (TI).

Definition 6. A verifiable choice (VC), is an ordered sequence of n CMs, Ψ=(Φ₁, . . . , Φₙ). A ballot commitment (BC) is a string H=hash(Ψ), where hash is a one-way hash function (possibly the identity function). (As noted above, the ballot in the above example contains only one question—generalization to multi-question ballots being straightforward. In this simplified case, a single VC takes care of an entire ballot. In the case of multiple question ballots, the BC, H would be computed by applying hash to the full ordered sequence of Ψs—one for each ballot question.)

VCs mean may divided into disjoint valid and invalid categories.

Definition 7. A VC, Ψ=(Φ₁, . . . , Φₙ) is valid if and only if
1. All Φⱼ are valid.
2. There is exactly one index, i, that satisfies τ(Φᵢ)=1. (So τ(Φⱼ)=0 for all j≠i.) In this case, the convenient notation i=τ_{Ω}⁻¹(1) may be adopted.

Definition 8. With Ψ as in definition 6, Ψ may be considered a vote for candidate i.

A structure that represents a “partially revealed” VC will now be defined.

Definition 9. An opened ballot mark pair (OBMP) is a 4-tuple β=(∈,m,ω,e) where ∈ is a message encryption (i.e. ∃\hat{m}∈M, \hat{ω}∈Ω with ∈=E(\hat{m},ŵ)), m∈M, ω∈Ω, and l∈{0,1}.

Definition 10. Continuing with the notation in the previous definition, there is a publicly computable mapping, U, from OBMPs to BMPs given by:

$$U ( β ) = \{ \begin{matrix}( E ( m , ω ) , ɛ ) & if ∈ = 0 \\ ( ɛ , E ( m , ω ) ) & if ∈ = 1\end{matrix} \qquad ( 3 )$$

Definition 11. An OBMP, β=(∈,m,ω,e), is well formed if m∈{Y,N}. Otherwise it is misformed.

Definition 12. An OBMP, β=(∈,m,ω,e), is valid if
β is well formed.
∃\hat{ω}∈Ω and \hat{m}∈{Y,N} such that ∈=E(\hat{m},\hat{ω}).

Equivalently, β is valid if and only if U(β) is valid. However, the definition first given highlights the fact that “well formedness” of β can be determined by inspection, while in order to determine whether β is valid requires knowing the decryption of ∈.

Definition 13. Let β=(∈,m,ω,e) be an OBMP. The bit function C may be defined by
C(β)=e (4)

Definition 14. Let β=(∈,m,ω,e) be a well formed OBMP. Let P be the bit function given by

$$P ( β ) = \{ \begin{matrix}0 & if m = N \\ 1 & if m = Y\end{matrix} \qquad ( 5 )$$

The next two definitions parallel the definition structure for VC.

Definition 15. An opened candidate mark (OCM), δ, is an ordered sequence of l OBMPs. It is well formed if all of its OBMPs are well formed.

Definition 16. An opened verifiable choice (OVC), Δ, is an ordered sequence of n OCMs. It is well formed if all of its OCMs are well formed. The OVC is essentially the encrypted voted ballot that is cast for tabulation. (Again, as with the definition for VC, this is true since the entire ballot consists of a single question. In the case of a multi-question ballot, the encrypted voted ballot will actually be an ordered sequence of OVCs. Nevertheless, the OCM may be occasionally referred to as the “encrypted ballot” below because equivalence of the two structures makes sense in this context.)

The function U of Definition 10 naturally extends to a function mapping OCMs to CMs and also to a function mapping OVCs to VCs simply by applying it element-wise, since OCMs and CMs are arrays of the same size, and also OVCs and VCs are arrays of the same size. To ease notation, all three of these functions by U may be denoted and distinguished between each other by context.

As with OBMPs then, OCMs and OVCs may be separated into valid and invalid via:

Definition 17. An OCM, δ, is valid if and only if the corresponding CM, U(δ), is valid. (In particular, δ must be well formed.)

Definition 18. An OVC, Δ, is valid if and only if the corresponding VC, U(Δ), is valid. (In particular, Δ must be well formed.)

The function P and C also extend to functions on OCMs and OVCs. The extension requires a bit more to describe, which is provided in the next two definitions.

Definition 19. Let δ=(β₁, . . . , βₗ) be an OCM. The function C(δ)∈Λ may be defined by
C(δ)=e(C(β₁)|C(β₂)| . . . |C(Bₗ)) (6)
where e is the encoding function and | represents bit concatenation.

Similarly, for well formed OCMs:

Definition 20. Let δ=(β₁, . . . , βₗ) be a well formed OCM. Let P(β)∈Λ be defined by
P(δ)=e(P(β₁)|P(β₂)| . . . |P(βₗ)) (7)

Definition 21. Let Δ=(δ₁, . . . , δₙ) be an OVC. Let C(Δ)∈Λⁿ (that is, C(Δ) is an ordered sequence of n strings from Λ) be defined by
C(Δ)ⱼ=C(δⱼ) (8)
Similarly, if Δ is well formed, define P(Δ)∈Λⁿ by
P(Δ)ⱼ=P(δⱼ) (9)

Looking at these functions in the inverse direction, one may think of “opening” a CM “according to c∈Λ, or “opening” a VC” according to (c₁, . . . , cₙ)∈Λⁿ, as is highlighted in the following definition.

Definition 22. For CM, Φ, and c∈Λ, define δ=O_{c}(Φ) to be the OCM, δ, given by
1. U(δ)=Φ
2. C(δ)=c

For \vec{c}∈Λⁿ, the extension to O_{\vec{c}} mapping (opening) VCs to OVCs should be obvious.

The importance of P and C is seen in the following lemma.

Lemma 1. Let Φ be a CM with τ(Φ)=0, and fix p∈Λ. Then there is exactly one c∈Λ with the property that P(O_{c}(Φ))=p.

The next three definitions build a definition structure for tabulation input that parallels the definition structure for VC and OVC. The first is rather superfluous, but it is introduced regardless in order to be most consistent with the other notation.

Definition 23. A tabulation input element (TIE), γ, is simply an encrypted message, γ=E(m,ω) for some (unknown) m∈M and ω∈Ω.

Definition 24. A TIE, γ=E(m,ω), is valid if m E {Y,N}.

Definition 25. A tabulation candidate mark (TCM), μ=(γ₁, . . . , γₗ), is an ordered sequence of l TIEs.

Definition 26. A TCM, μ=(γ₁, . . . , γₗ) is valid if
1. γⱼ is valid for all 1≦j≦l.
2. All γⱼ are encryptions of the same message, m. So either all γⱼ are independent (different ω) encryptions of Y—in which case μ is “type 1” and write τ(μ)=1, or they are all independent encryptions of N—in which case μ is “type 0” and write τ(μ)=0. (To be fully consistent with definition 4, one may also write τ(μ)=−1 if μ is invalid.)

Definition 27. A encrypted choice (EC), I=(μ₁, . . . , μₙ), is an ordered sequence of n TCMs.

Parallel to Definitions 7 and 8 two definitions follow:

Definition 28. An EC, I=(μ₁, . . . , μₙ), is valid if
1. μⱼ is valid for all 1≦j≦n.
2. There is exactly one index, i, that satisfies τ(μᵢ)=1. (So τ(μⱼ)=0 for all j≠i). In this case write i=τ₁⁻¹(1).

Definition 29. With I as in Definition 28, I is a vote for candidate i.

Therefore, a connecting transformation is:

Definition 30. There is a publicly computable mapping, W, from well formed OBMPs, β=(∈,m,ω,∈), to TIEs given by:

$$W ( β ) = \{ \begin{matrix}ɛ & if m = Y \\ T ( ɛ ) & if m = N\end{matrix} \qquad ( 10 )$$

where T is the encrypted message inversion function.

As with the function, U, the function W extends naturally to a function from OCMs to TCMs, and to a function from OVCs to ECs by applying it coordinate wise. As was the case with U, all three of these functions may be denoted by W, and distinguished between each other by context.

The transformation, W, is found in the main lemma of this section.

Lemma 2. Let Ψ be a VC and c any element of Λ.
1. If Ψ is valid, then Υ=W(O_{c}(Ψ)) is valid and τ_{Υ}⁻¹(1)=τ_{Ψ}⁻¹(1) (i.e. both are votes for the same candidate).
2. If Ψ is invalid, then either O_{c}(Ψ) is misformed, or O_{c}(Ψ) is also invalid.
   Proof: Follows directly from the properties of T.

A Protocol from the Data Structures

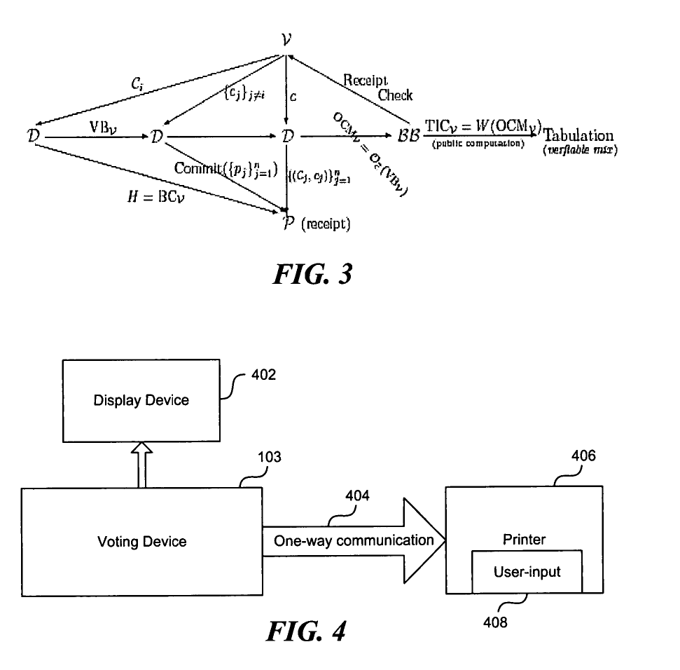

A data flow representing a protocol based on the above protocol data structures is shown pictorially in FIG. 3. Specifically, the protocol includes the following, which clarify blocks under FIG. 2:
After receiving the Cᵢ from V in step 204, D generates random encryption seeds (ω) and computes a valid VB, VBᵥ, which is a vote for candidate Cᵢ (V's indicated choice). D can choose the order of Y and N encryptions in the type 0 CMs, Φⱼ, so that the order is (N,Y) if the corresponding bit of xⱼ is 0, and is (Y,N) if the corresponding bit of xⱼ is 1, for all j≠i. For the type 1 CM, Φᵢ, in position i, D can choose (N,N) or (Y,Y) encryption pairs precisely so that for all c∈Λ, P(O_{c}(Φᵢ))=xᵢ.
In block 206, the value H written to P is exactly the BC (see Definition 6) corresponding to VBᵥ, BCᵥ, computed in block 204.
After receiving the c from V in block 212, D “opens” VBᵥ according to \vec{c}=(c₁, . . . , cₙ) creating V's OCM (encrypted ballot), OCMᵥ, which is posted to BB:
   OCMᵥO_{\vec{c}}(VBᵥ) (11)
Since both \vec{c} and \vec{p} can be computed by anyone from the posted OCMᵥ, V need only
   1. Compare the value of H printed on its receipt to the value of H computed from the copy of OCMᵥ posted to BB (the public “ballot box”).
   2. Compare the printed \vec{c} and \vec{p} on its receipt with the corresponding values computed from the copy of OCMᵥ posted to BB.
to complete its verification of encrypted ballot integrity.
The verification properties follow from Lemmas 1 and 2.

Remark 1. The scheme resists coercion (under the random number generation (RNG) assumption), since all cⱼ are chosen freely (and hence symmetrically) by V. Only V knows which one was chosen after the commitment of {pⱼ}ⱼ₌₁ⁿ.

Remark 2. It is not necessary to restrict V's choice of cⱼ (and c) to Λ. As a “usability feature,” longer “personal pass phrases,” Phᵥ, could be accepted. The protocol would simply compute “the modulus of Phᵥ relative to l, or a hash of it into Λ. This may encourage greater randomness from the voters in choosing their challenges.

Some Variations and Alternative Embodiments

Many variations exist for aspects of the above embodiments and protocols exist. By using one or more of these variations in place of the specific steps described previously, many alternative embodiments can be built.

1. Printer Pledge Commitments on Separate Tape

The voter/device interaction presented in FIG. 2, is similar to the interaction that takes place when voting with typical direct recording equipment (DRE) at poll sites. Besides the usual candidate display and selection, there are three very simple additional steps, the first of which the voter may ignore if desired. They are:
1. (Optional) Voters are given the option to select n-1 arbitrary short strings before ballot commitment.
2. Voters should check to see that the ballot commitment has been completely printed (terminated by a known end string, for example).
3. Voters need to pick one short string, c, and check that it and the corresponding p are printed appropriately. (The time for this to take place is very short which means it will be very easy for voters to perform this check.)
   Nevertheless, a variation on the protocol, described below and using a more specialized printer, requires even less from voters.

Consider a two headed printer (or two printers), the first of which is capable of erasing or destroying its output, the second being generic. The pledge, xᵢ=pᵢ for candidate Cᵢ can be printed (behind shield) with print head 1, as a commitment. The voter then needs only to pick c (not the cⱼ for j≠i), with the understanding that D is required to open all CMs with the same value, c. The printer must then print, with print head 2, a single line containing c and then Cⱼ lines with pⱼ in place of cⱼ. V then verifies that the printed value of c matches her choice, and that the value of pᵢ is the same as the values committed by print head 1. The output of print head 1, combined with the output of print head 2 (the voter's receipt) gives evidence of the voter's choice. But if the output of print head 1 is destroyed, this evidence is eliminated.

A desirable aspect of this embodiment is that all verification steps that are not part of a generic direct recording equipment (DRE) voting experience can occur after the ballot commitment step—the point that would typically be referred to as ballot “casting.” As a matter of convenience, this implies an especially nice consequence: the selection of Voter Unchoice Challenges in block 208 is irrelevant, and the step can be removed.

2. Shared Computation of the Verifiable Choices

The Voting Device model in the embodiment initially presented assumed that the bit stream, [symbol] , could not be distinguished from a random bit stream by the coercer, C. In practice, this amounts to assuming that the coercer has not been able to somehow compromise the Voting Device software or hardware.

Such compromise is likely to be difficult, and as noted previously, would not limit the power of the protocol to provide each voter with evidence of any attempt by the Voting Device, D, to alter the voter's ballot choices. However, it could potentially undermine the secrecy of some or all voter choices, or it may allow for some form of vote coercion.

Thus it is desirable to consider an alternative embodiment that does not require the Voting Device, or any other possibly untrustworthy entity, to implement [symbol] . The most desirable solution then should symmetrically share the implementation of [symbol] between the Election Authorities, Aᵢ. An embodiment with this characteristic can be obtained as follows:

Overview

Before voting begins, the jurisdiction decides on a maximum number of “blank ballots,” N_{B}, that will be required for the election. (This step is also needed in paper ballot elections. The value of N_{B} needs to be at least as large as the total number of voters expected to turn out, and in practice needs to be a bit larger to insure against some ballot loss, and occasional voter ballot marking errors.) The Election Authorities, Aᵢ, then cooperate to produce a sequence of N_{B} verifiable choices (VCs) which are the VCs that are used by the Voting Device as in the embodiment first presented. All random choices required to form each VC (i.e. those referencing [symbol] ) are thus symmetrically shared among the Election Authorities instead of being determined by the (possibly untrustworthy) Voting Device, D.

The cooperative action of the Election Authorities will now be described in greater detail. For the purpose of this description, refer to a sequence of N_{B} VCs as a Blank Ballot Stack.

Election Authority Computation Steps

Much as in shuffle or mix-net tabulation, the Election Authorities, Aᵢ, construct, in sequence a Blank Ballot Stack. Each Election Authority uses as input to its construction the Blank Ballot Stack that was output by the previous Authority. The first Authority in the sequence uses as input a fixed, publicly known Blank Ballot Stack—that is the starting point of the computation is always the same.

The authorities are numbered, A₁, . . . , Aₙ according to their order in the computation sequence. Let bᵢ₋₁ be the Blank Ballot Stack output by Aᵢ₋₁, which is then also the Blank Ballot Stack taken as input by Aᵢ. The computation performed by Aᵢ proceeds as follows:
BBS.1. For each Verifiable Choice, Ψ_{(i-1,j)}, in bᵢ₋₁, execute the steps:
   BBS.1.1 Choose a random permutation, π_{(i,j)}∈Σₙ. (Recall that n is the number of “candidates,” or possible responses to the question on the ballot.)
   BBS.1.2Let (Φ_{(i-1,j,1)}, . . . , Φ_{(i-1,j,n)}) be the representation of Ω_{(i-1,j)} as a sequence of Candidate Marks.
   BBS.1.3For each Φ_{(k-1,j,k)}, 1≦k≦n
      BBS.1.3.1 Let (φ_{(i-1,j,k,l)}, . . . , φ_{(i-1,j,n)}) be the representation of Φ_{(i-1,j,k)}, 1≦k≦n as a sequence of Ballot Mark Pairs (BMPs).
      BBS.1.3.2 For each 1≦1≦l, choose randomly a bit, bₗ, bₗ∈{0,1}. If bₗ=0, set \overline{φ}_{(i-1,j,k,l)}=φ(i−1,j,k,l). Otherwise (i.e. if bₗ=1), set \overline{φ}_{(i-1,j,k,l)}=F(φ(i−1,j,k,l)) using the function F defined below.
      BBS.1.3.3 Set \overline{Φ}_{(i-1,j,k)}=(\overline{φ}_{(i-1,j,k,l)} . . . \overline{φ}_{(i-1,j,k,l)})
   BBS.1.4Set Φ_{(i,j,k)}=Φ_{(i-1,π}_{_{(i,j)}}₍ₖ₎₎
BBS.2. Set Ψ_{(i,j)}=(Φ_{(i,j,1)}, . . . , Φ_{(i,j,n)})
BBS.3. Output bᵢ={{Ψ_{(i,j)}}ⱼ₌₁^{N}^{_{B}}}

The function F is defined by
F((X₀,Y₀),(X₁,Y₁))=(T(X₀,Y₀),T(X₁,Y₁)) (12)
where, as previously defined, T is the encrypted message inversion function.

Additional Details

The final Blank Ballot Stack, bₙ, must be communicated to the Voting Device along with all the individual permutations, π_{(i,j)} and the randomly chosen bits bₗ. The π_{(i,j)} and the bₗ must be communicated secretly. Ideally, the Voting Device has a secure cryptographic module capable of exporting a public key. If so, the secret communication can easily be implemented using public key encryption. If not the Voting Device does not have a secure cryptographic module, other conventional methods for secure communication such as supervised transport of physical media can be used. The combination of bₙ, all π_{(i,j)}, and all bₗ is sufficient information for the Voting Device to execute the verification protocol as previously described using the predetermined Verifiable Choices in bₙ instead of Verifiable Choices chosen by the Voting Device. Thus the need for any Voting Device chosen random bits is eliminated.

3. Pledge Commitment on the Voting Device

An important aspect of the protocol first described above is the pledge commitment presented by the Printer. A purpose of this event is to convince the Voter that a particular string of data that will be shown to the Voter later—the pledge, pᵢ—is completely independent of the Voter's arbitrarily selected challenge string. Ideally, the Voting Device would simply show pᵢ before the Voter communicates the challenge string, but this would allow the Voter to correlate the challenge string with pᵢ, thereby enabling the threat of coercion. Thus it is important that the Voter be unable to see the value of pᵢ until after communicating the challenge string.

Under the model above for the Voting Device, D, and the Printer, P, it is not possible to show the Voter the pledge string, pᵢ, by using the Voting Device's display, or monitor, because of this constraint. However, under at least one alternative embodiment it is possible. For example, by extending the model of the Printer and Voting Device very slightly in two ways, it is possible to use the Voting Device's display to show pᵢ in an indirect way. The two additional properties are:
Printer: The Printer, P, is capable of direct Voter input. Specifically, it should be possible for the Voter to communicate a string to P without any involvement of the Voting Device. The type of user-input required is very simple—a small numeric, or alpha-numeric keypad is sufficient. Each Voter will only need to enter one short character string (2-4 characters in length) during the vote verification process.
Voting Device: The Voting Device can be physically disconnected from the Printer, either permanently or temporarily. In this case, “physically disconnected” implies that an observer can determine that all communication from the Printer to the Voting Device is prevented. (Communication from the Voting Device to the Printer is allowed, thus communication in one-way from the Voting Device to the Printer.) An example of such an arrangement is shown in FIG. 4, showing a display device 402 coupled with the voting device 103, which has a one-way communication channel 404 with a printing device 406. The printing device in turn has a user-input portion 408. (As is clear from the detailed description herein, while the voting device 103 is shown, the voting computer 102 or other computing device may be employed.)

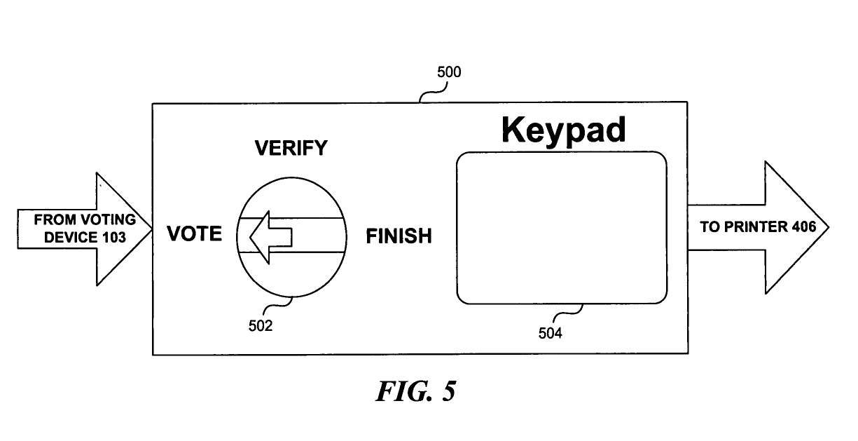

There are several methods by which one can observably enforce the communication restriction between Printer and Voting Device. A few such of methods include:
If all communication between Printer and Voting Device is done by way of physical transport of media (e.g. a smart card handled by the Voter), this restriction can be enforced simply by way of voter education.
If the Printer and Voting Device communicate by cable or wire, allow the Voter to physically disconnect the two devices at an appropriate time. This can be made convenient by installing an “on/off” switch box in the communication cable, which itself may have a keypad (thus avoiding the need for a user-input device on the printer 406). FIG. 5 shows an example of this alternative as a unit 500, which has a switch 502 and keypad 504. Moving the switch 502 from the “vote” to the “verify” position disconnects the Printer from the Voting Device. Moving the switch 502 to the “finish” position reconnects the Voting Device to the Printer to finish printing the receipt and to allow the voter to confirm his or her choices.
Install a physical “one-way” communication channel between the Printer and the Voting Device. A simple example might be an infrared link between the devices with only a transmitter at the Voting Device and only a receiver at the Printer.

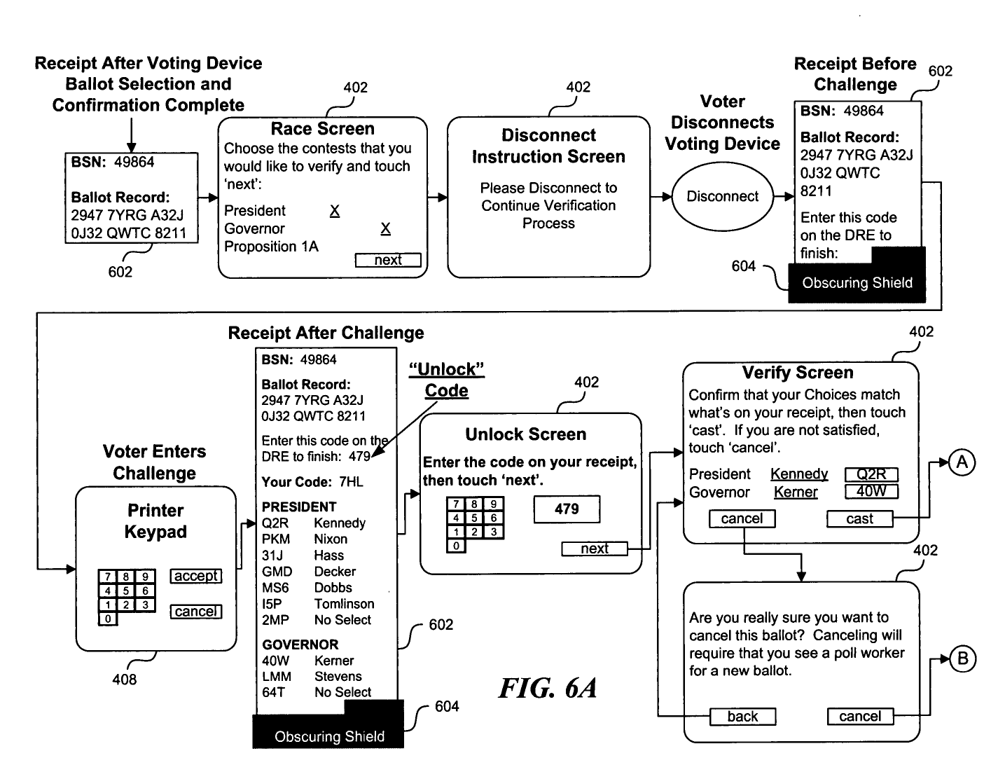

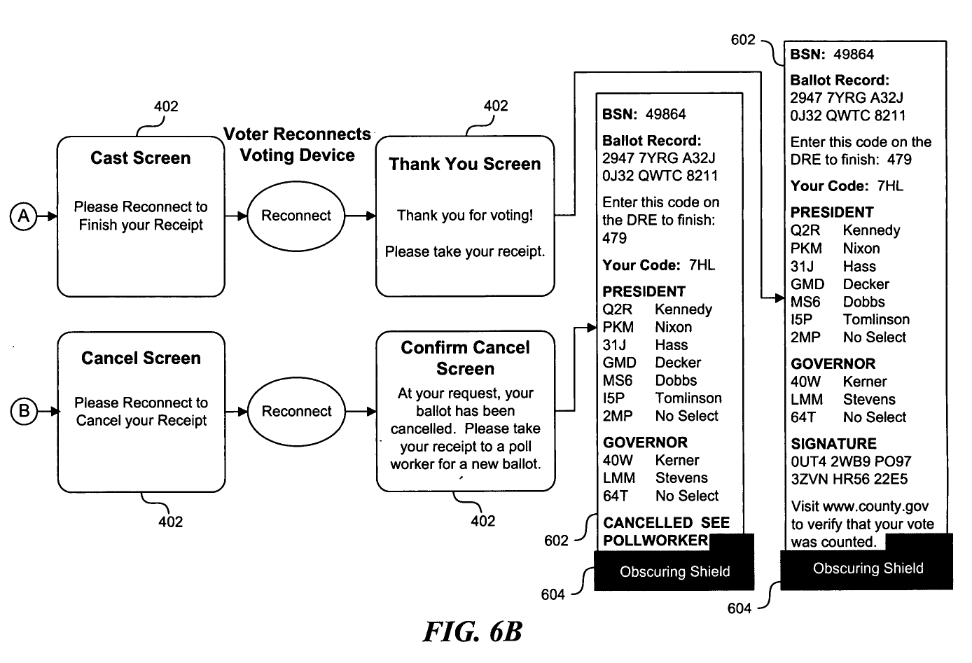

FIGS. 6A and 6B together illustrate steps of this embodiment, and are generally self explanatory based on the detailed description provided herein. As shown, a series of suitable displays screens providing information and instructions are shown via the display device 402. A receipt 602 is progressively printed by the printer 406 during the voting process, and an obscuring shield 604 on the printer is provided (as explained above).

The Voting Device does not know the pledge string(s) at all until it is given the unlock string. The unlock string is used as a decryption key to a (list of) encrypted pledge string(s). Thus the Voting Device is prevented from showing pledges too early.

Note that in the case of a one question ballot, which represents the simplified ballot discussed above, this embodiment offers little advantage. However, if the number of questions on the ballot is large, this embodiment provides a convenient way for the Voter to issue only one challenge string, instead of the one challenge string per ballot question.

4. Authority Selected Challenge Strings

As previously mentioned, a purpose of the Voter selected challenge string is to convince the Voter that the associated pledge string (as determined by the Verifiable Choice already committed by the Voting Device) does not depend on the value of the challenge string selected. An alternative approach would be to let the Election Authorities symmetrically share the responsibility for selecting the challenge strings.

It is possible to accomplish this. As in the Shared Computation of the Verifiable Choices section above, prior to the start of voting, each Election Authority would generate a list of a sufficient number of “challenge shares” and make some public commitment (e.g. publish a hash) of their challenge share list. The challenge issued by each Voter is then required to be some symmetric algebraic combination (e.g. XOR) of the Authority challenge shares, and the validity of this requirement with respect to each Voter receipt would be checked as part of election tabulation and audit.

In practice, implementing this solution will some procedural or structural additions to the above system:
1. Communicating to each Voter the Voter's challenge shares with appropriate level of secrecy.
2. Enabling each Voter to perform the proper algebraic combination of challenge shares without error.
Various ways exist for implement the above additions within the above protocols. For example, assuming appropriate safeguards, a central facility would receive the challenge shares from the Election Authorities and prepare scratch-off sheets having several challenge strings. One such sheet would be provided to each voter at the poll, and the voter may scratch off to reveal one of the several preprinted (but obscured) challenge strings that could then be used in voting. Alternatively, the voter would receive two or more scratch-off sheets, and then mentally combine challenge shares from two or more scratched-off sheets to produce a challenge string, thus avoiding the need for the central facility to combine the shares prior to printing of the sheets.

Overall, while the alternative described in the Shared Computation of the Verifiable Choices section pushes random choices in the ballot formation to the Election Authorities, the alternative described in this section also provides to the Election Authorities any random choices that a voter is required to make (i.e., challenge strings/codes), further anonymizing or insulating the voter from the voting process (which is unavailable in any “show-of-hands” election).

5. Remote Voting

The above protocol and all of its variations can also be used in the context of a remote, or unattended voting system—that is one where the act of voting is not restricted to a supervised poll site. Examples of such systems include Internet voting systems (e.g. the voter computers 102), and unattended kiosk voting systems. A limitation is that since the physical equipment used by the voter can not logistically be supervised and inspected, it may be possible for Voters to circumvent the constraints that prevent them from knowing the value of their committed pledge, pᵢ, before selecting and communicating their challenge string.

Thus, aspects of the invention are perfectly applicable to remote voting systems for the purpose of vote verification—that is, Voters can use the protocol in one of its several embodiments to assure themselves that their ballot has been cast correctly, and demand a valid receipt for it. This receipt does not provide information in the public tally indicating which ballot choices Voters made. However, coercion may not be completely prevented.

Since all conventional remote voting systems (e.g. vote by mail) are coercible by way of “shoulder surfing,” a verifiable, but potentially coercible remote system may be acceptable in practice.

There are also several ways to minimize the coercion threat in practice. Examples include:
1. Distribute secure hardware, such as a Printer or like device, as noted above. Such hardware could authenticate itself and prove via digital signatures that it was used as specified by the protocol.
2. Simulate the physical commitment of data by way of data encryption. In effect, instead of printing the pledge string behind an obscuring shield, commit it to the Voter by delivering an encryption of the pledge string—after the Voter replies with a challenge, deliver the decryption seed.
3. Use the embodiment described for Authority Selected Challenge Strings.

6. Alternative Ballot Encodings

The data structures described above constitute only one example of a very broad class of data representations that can support aspects of this invention. Abstractly, some requirements are
1. The data structures should be able to represent two sets of code words, a set of CHOICE code words, and a set of UNCHOICE code words. Consider, for example, the data structures above, and make the trivial identification of Y with “1 bit” and N with “0 bit.” Then the CHOICE code words can be identified with the set of binary strings b₀,b₁, . . . ,b₂ₗ₋₁ of length 2l which have even parity when restricted to each of the l bit pairs (b₀,b₁), . . . , (b₂ₗ₋₂,b₂ₗ₋₁), and the UNCHOICE code words can be identified with the set of binary strings b₀, b₁, . . . , b₂ₗ₋₁ of length 2l which have odd parity when restricted to each of the l bit pairs (b₀,b₁), . . . , (b₂ₗ₋₂, b₂ₗ₋₁)
2. There should be an encryption function capable of “codeword hiding” in the sense that essentially no information about the specific value of a code word can be determined from an encryption of it. Above, the encryption function used was coordinate-wise ElGamal encryption. The encrypted code words are the Candidate Marks (CMs).
3. There should be a parameterized “partial reveal” function operating on encrypted code words that produces both data suitable for input to a tabulation process, and an output parameter (i.e. pledge value). Again, under the first described process above, the parameterized “partial reveal” function used is O_{c}(Φ), parameterized by c and operating on the CM, Φ. The input parameter space is the set of strings of correct length from the encoding alphabet. The output parameter is p=P(O_{c}(Φ)).
4. In order that the receipt not reveal the voter's candidate choice, the relationship between O, c and p must be further constrained as follows:
   If there exists an element, c, of the input parameter space, encrypted CHOICE code word, Φ, and output parameter p all with the property that p is the output parameter obtained by applying the parameterized partial reveal function to Φ with parameter c, then there is an element, c′, of the input parameter space, and encrypted UNCHOICE code word, Φ′, such that p is also the output parameter obtained by applying the parameterized partial reveal function to Φ′ with parameter c′. Further, the same should hold with the roles of CHOICE code word and UNCHOICE code word reversed.

Example Encoding Alternatives

Swap Even/Odd Parity: A trivial example of a data structure alternative would be to use “odd parity” pairs for CHOICE code words and “even parity” pairs for UNCHOICE code words. (This is simply the reverse of the convention presented above) To be consistent, one must also make the corresponding obvious change to tabulation convention.

Orthogonal Group Encoding: A more interesting example of an alternate encoding is based on the structure of finite special orthogonal groups. Consider a subgroup, G, of SO₂ (q) of order 4m, where m>0 is an integer. The elements of this group are 2×2 matrices over Fq.

Let X be a generator of G, G_{C}={X⁴ⁱ}, G_{U}={X⁴ⁱ⁺²} and G_{T}={X²ⁱ⁺¹}.

Use the top row vectors of elements of G_{C} as CHOICE code words, the top row vectors of elements of G_{U} as UNCHOICE code words.

The encryption of a code word (x,y) is a pair of ElGamal pairs given by
((g^{ω}^{₁},h^{ω}^{₁}g^{x}),(g^{ω}^{₂},h^{ω}^{₂}g^{y}))
where ω₁ and ω₂ are random encryption exponents as before.

The challenge parameter space is identified with the top row vectors of G_{T} modulo scaler multiplication by −1∈F_{q}, and the set of logarithms base g of the elements of the pledge parameter space is identified with the set of standard inner product values (over F_{q}²), {u·v} where u is a CHOICE code word and vv is an element of the pledge parameter space. (Note that the span of these values is identical with {w·v} where w is UNCHOICE code word and v is an element of the pledge parameter space.)

The partial reveal operation with challenge parameter c=(c₁,c₂) applied to an encrypted code word is the unencrypted value of the ElGamal pair
(g^{c}^{₁}^{ω}^{+c}^{₂}^{ω}^{₂},h^{c}^{₁}^{ω}^{₁}^{+c}^{₂}^{ω}^{₂}g^{c}^{₁}^{x+c}^{₂}^{y})
which is simply g^{c}^{₁}^{x+c}^{₂}^{y}—an element of the pledge parameter space.

Note that the ElGamal encryption of the pledge value, above, can be computed publicly by modular multiplication. The decrypted value can be revealed by standard decryption proof of validity techniques.

An advantage of this method is that only one pair of ElGamal pairs is needed to implement very large pledge and challenge spaces. In section 4.2.2, l ElGamal pairs are required to implement a pledge/challenge space size of 2′. Thus this encoding offers significant practical advantages with respect to data size and computational complexity.

7. A Suitable User-Interface

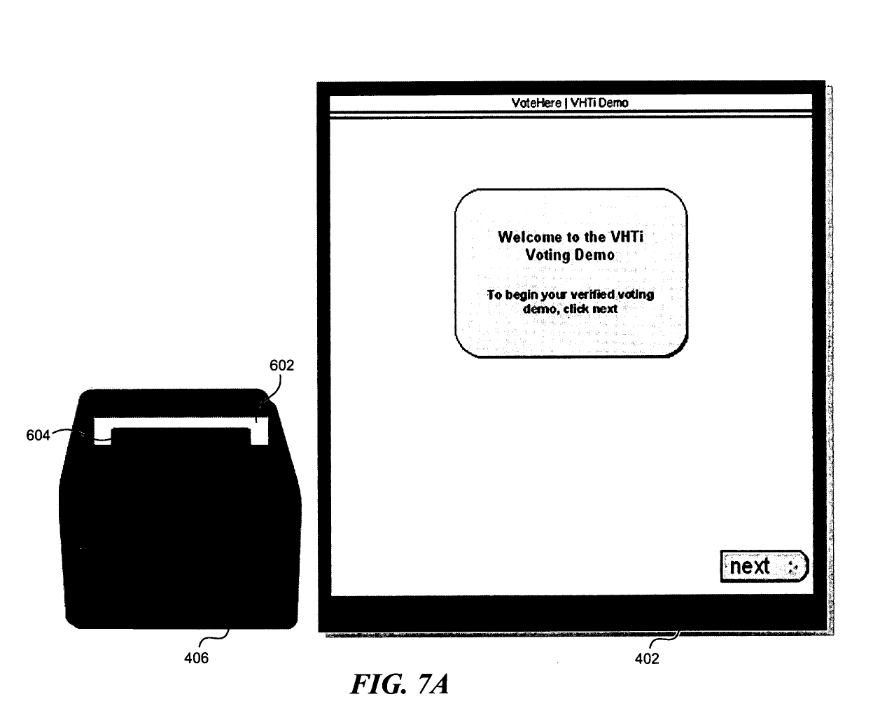

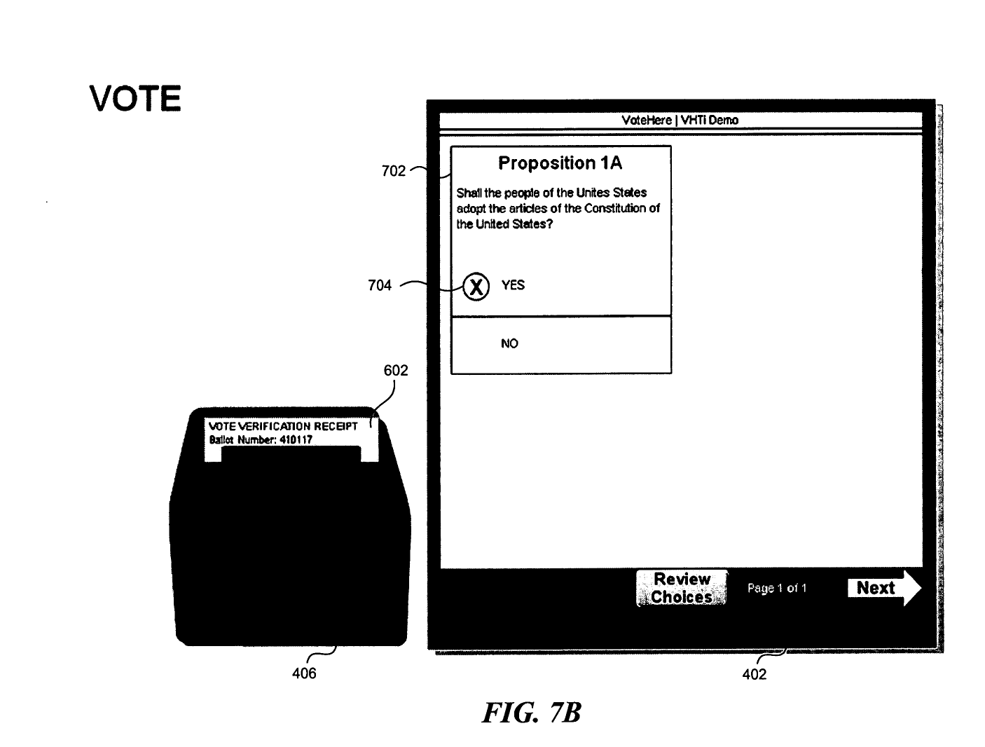

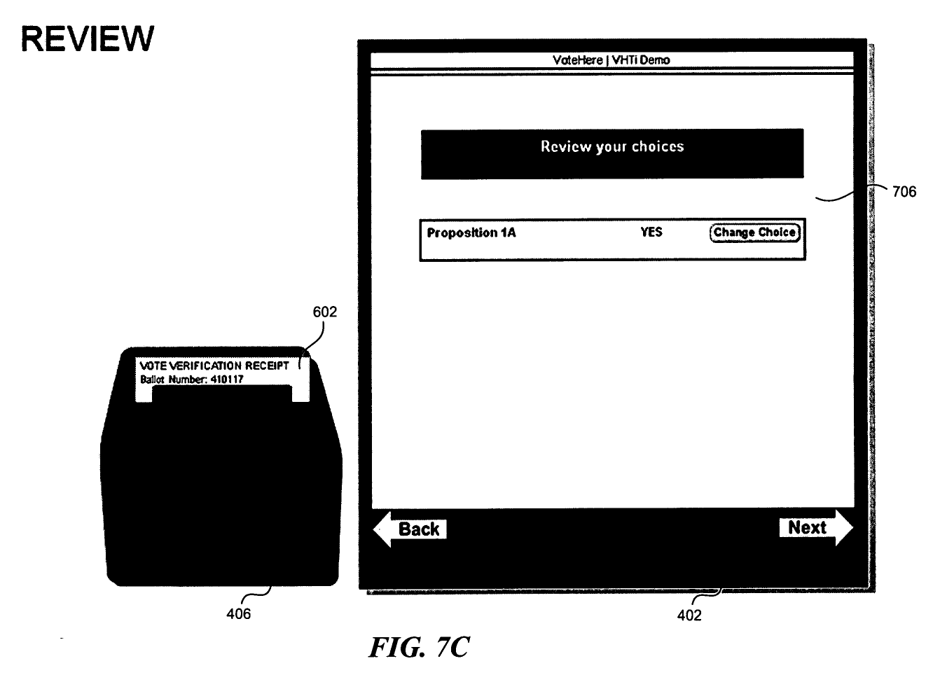

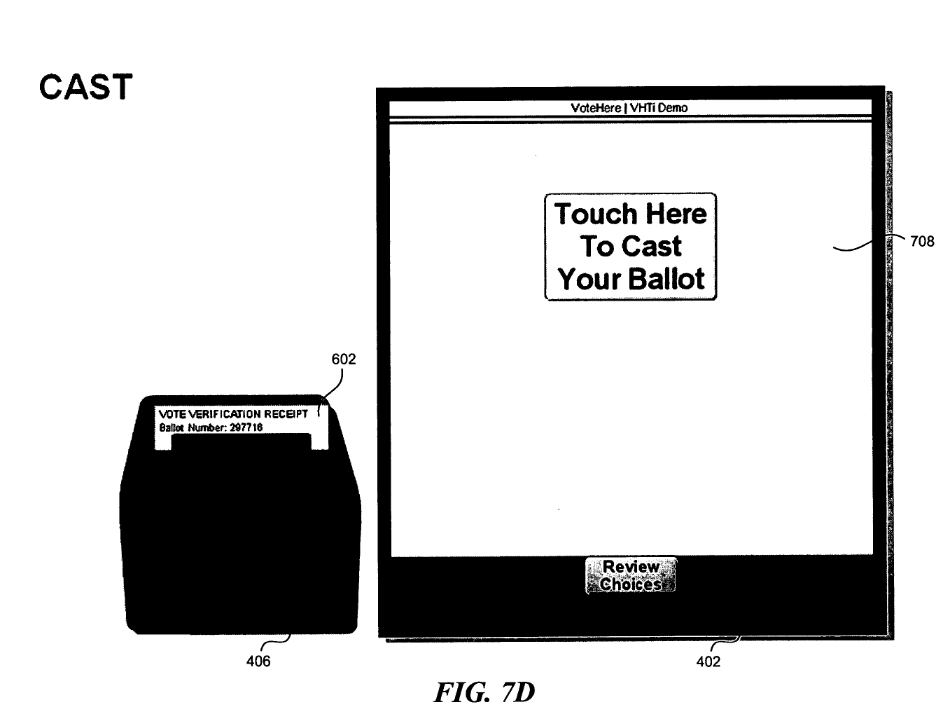

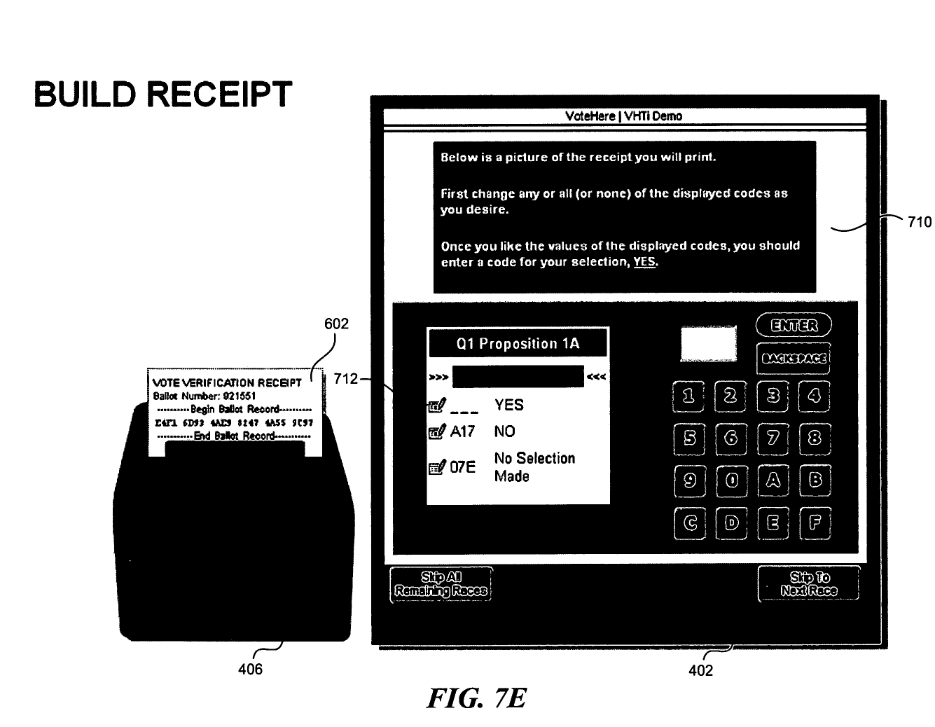

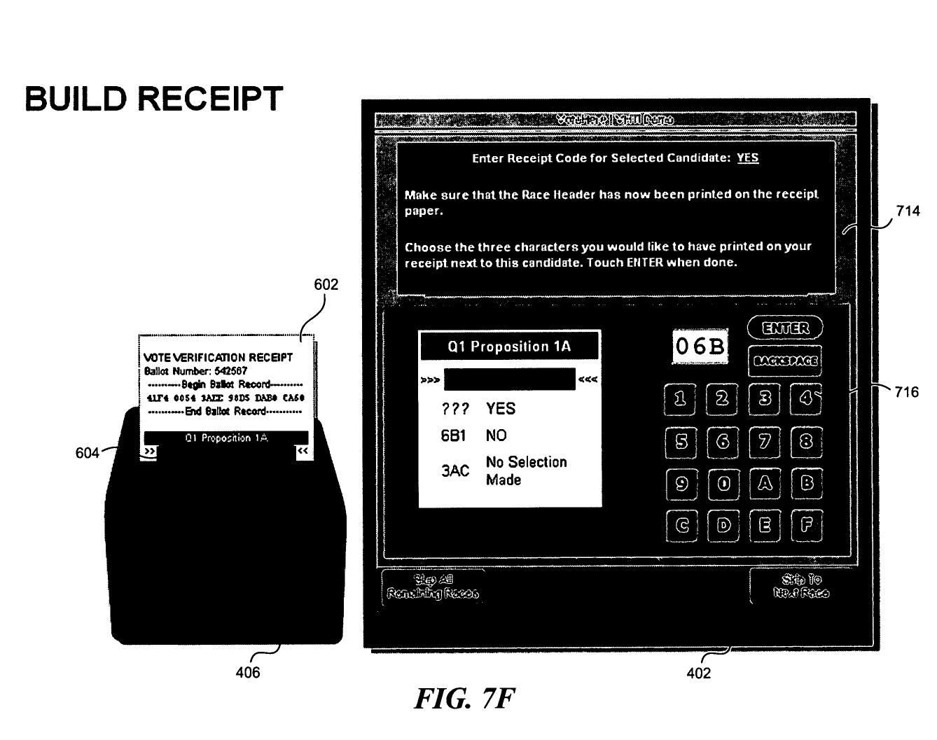

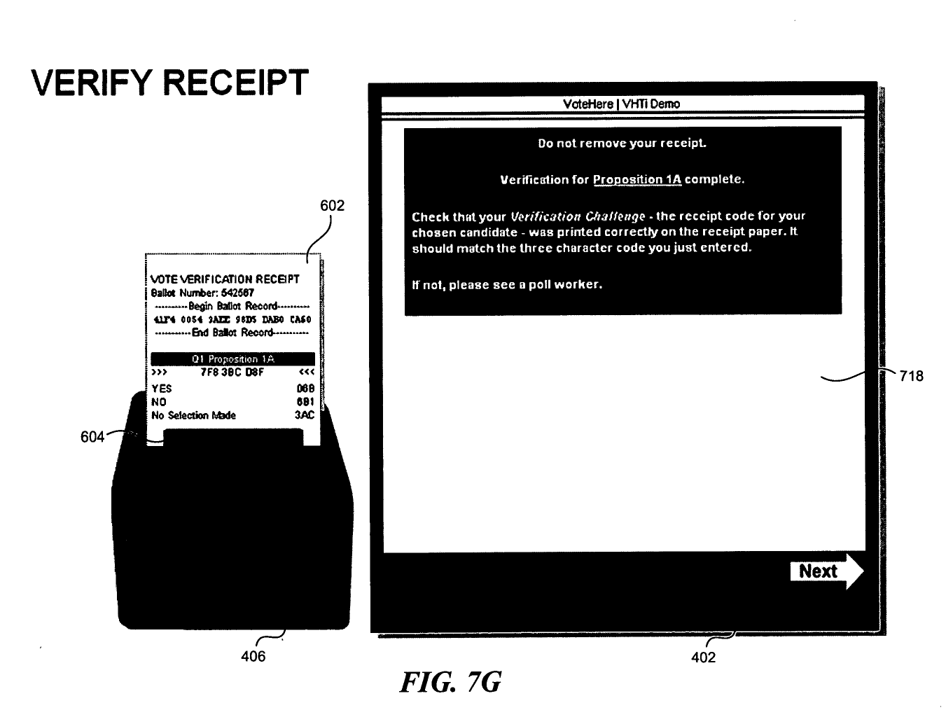

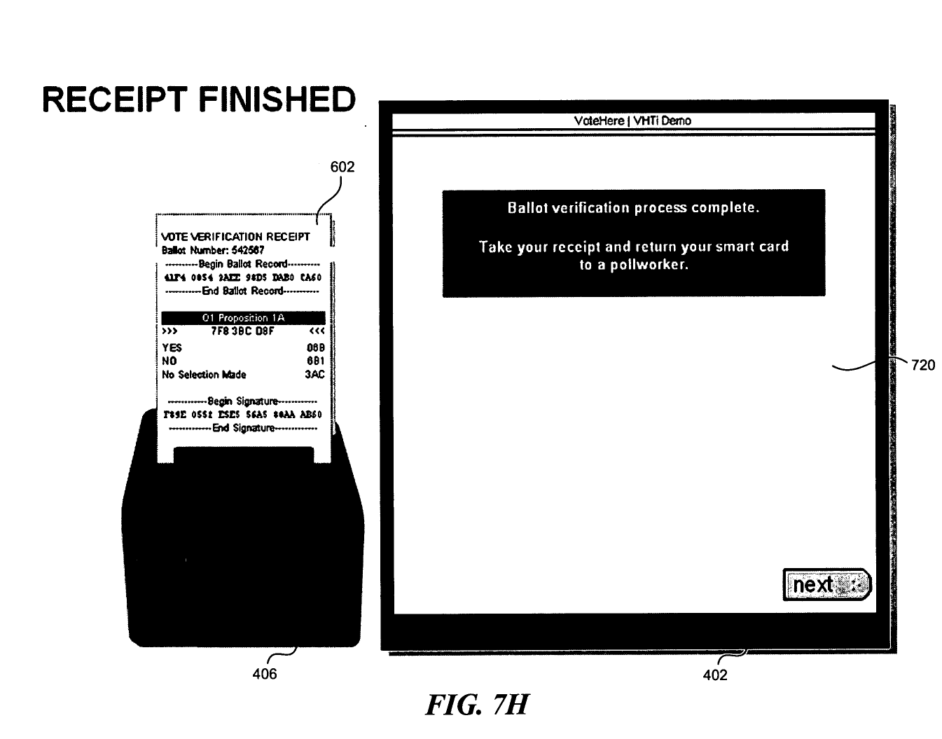

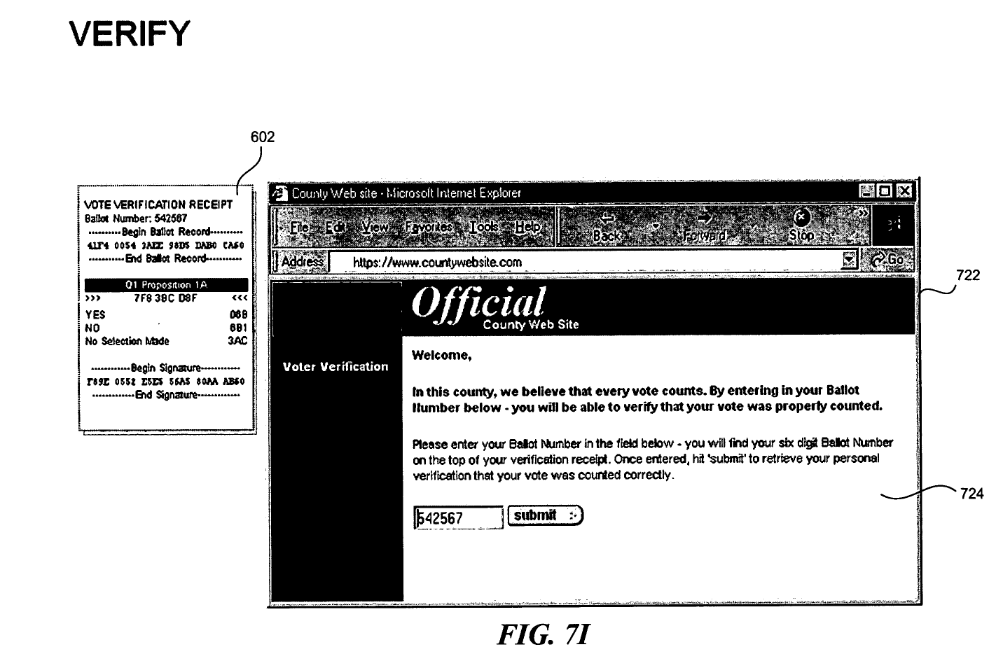

FIGS. 7A through 7I show one example of a voter's experience with the voting protocol first described above. As shown, a series of information screens and instructions are provided, such as via the display device or to or any suitable device. In this embodiment, a touch sensitive display is provided to permit the voter to select onscreen choices. For example, after receiving an introductory display shown in FIG. 7A, the voter may touch a “Next” onscreen button to display a ballot question 702 and select a desired choice 704, as shown in FIG. 7B. The display device 402 may display a summary of voter choices in a screen 706, and then permit the voter to touch the screen 708 to cast his or her ballot (FIG. 7D). FIG. 7E shows an instruction screen 710 that allows the voter to click an edit icon 712 to input a challenge code. The voter may input the code via a keypad 716 (in this instance, the code “06B”). By clicking the edit icon 712, the printer prints a verification challenge (obscured by the printer shield 604).

The voter may also vote on additional races or ballot choices, which may entail repeating some of the above steps. Screen 718 of FIG. 7G provides additional instructions to the voter, while screen 720 of FIG. 7H provides a final or near final screen to the voter at the close of the voter's voting process. FIG. 7I provides an example of how the voter may then use his or her receipt 602 to confirm that his or her vote was included in the ballot tally. For example, the voter may access the Internet 106 via a browser window 722 on any computer (such as the voter computer 102), and obtain a screen 724 to input identifying information (such as a ballot number), and access information that may be compared with the voter's receipt 602.

8. A Verifiability Alternative: Secret Codebooks/Dictionaries

An alternative embodiment or scheme employs “codebooks” or “dictionaries”. For most of following description, the ballot in question consists of a sequence of N_{Q} “questions” (these might also be called “issues” or “candidates”), and that for each question, Q, voters are allowed to choose an ordered sequence of m_{Q} “responses” from a list of n_{Q}≧m_{Q} fixed “answers”. Ballots that have these properties are “standard ballots”. Standard ballots support most types of election tabulation methods. For example, preferential voting can be supported by sequencing voter responses to a particular question in order of the voter's preference. In fact, to simplify notation, only the specifics of the case N_{Q}=1 and m=m_{Q}=1 will be discussed. There are no special difficulties that occur in the case of larger values. One skilled in the art will easily see that the methodology allows more complicated ballots to be viewed as a collection of “parallel elections” with N_{Q}=1 and m=1.

Although standard ballots, as defined, do not include “write-in” responses, this alternative embodiment can be used to support ballots that include “write-in” responses in several ways. Briefly, two such ways are:
1. A distinguished “write-in” response can be included among the possible responses for any given ballot question. This response is used only as a flag at tabulation time to indicate that an “attached” encrypted text field should be decrypted after ballot mixing (shuffling) and counted. Direct use of the systems noted herein can then facilitate verification of the fact that “a write-in choice will be counted,” however, it will not provide verification that the actual text “to be counted” was recorded correctly. For example, the voter may “write-in” the string Joe Smith, but the voting device would be able to undetectably change this to the string Mickey Mouse. In some elections, this level of verification may be sufficient.
2. Each letter, or character of the “write-in” string can be recorded as a response to a separate “question.” The voter would then cast a “vote” for the first character of “write-in” string, then cast a vote for the second character of the “write-in” string, etc. This provides a solution to the problem of collecting “write-in” responses in the context of a standard ballot.

Further since the details of the necessary modifications to the embodiment described herein should be obvious to one skilled in the art. Note that such “write-in” responses may create inherent coercion problems—problems that are not tied to this alternative embodiment. If any “write-in” response is allowed, a vote coercer can determine if a voter voted the entire ballot according to instruction by demanding that voter provide a known unique string as a particular write-in response.

One may assume that the voting device is incapable of distinguishing voter identities. In particular, the voting device can not predict whether a given voter is more or less likely to audit the voting device's behavior as described by this technique. This is an important assumption, but it can be realized in practice through a combination of vote process design, and restrictions on machine hardware.

Vote Receipts

Already, under procedures currently used at poll sites, open publication of voted ballot data is not harmful. This is because the link between voter (individual) and ballot is procedurally lost at the poll site. This is true even if unique identifying marks, or ballot sequence numbers (Ballot Sequence Numbers), are assigned to each ballot, as long as the procedure by which each voter obtains a Ballot Sequence Numbers sufficiently unpredictable. In the paper ballot setting, one can imagine each voter choosing a blank ballot paper from an arbitrary place in a large pile of blank ballots, and procedurally destroying the ballot papers that are left at the end of the voting day. There are better ways to achieve arbitrary distribution of Ballot Sequence Numbers with electronic ballots, but it need not be discussed in detail here.

Assuming then that voters know their own Ballot Sequence Number, but that no other election participant does, publication of voted ballot data allows all voters the chance to verify that their ballot was correctly included in the final count. Any misbehavior by the poll site voting machine would be detected by the process of verification, however this is of limited value since voters have no way of proving that their ballot was altered. Since it is unreasonable to assume that all voters are honest, election integrity can not be firmly established. Further, the very act of mounting a protest spoils the voter's right to ballot secrecy.

Financial transactions have long dealt with this issue by the mechanism of a receipt. By issuing a “vote receipt” of indisputable authenticity to voters after they have confirmed and committed their choices, the problem of election dispute can be resolved. However, the act of protest would still spoil the voter's ballot secrecy, and a new, more sinister problem is created: Since voters have been enabled to prove how they voted, they are vulnerable to the threat of vote coercion. What is required is an indisputable receipt, for which only the voter can determine a meaningful connection to specific ballot responses.

Voted Ballot Representation

The specific form of a receipt with desirable properties will unavoidably be determined by the accepted representation standard for blank and voted ballots. For the discussion below, a Blank Ballot is simply a Ballot Sequence Number along with an ordered sequence of Answer Marks. The order of the Answer Marks determines precisely how they correspond to the available ballot answers. A Voted Ballot is simply a Ballot Sequence Number along with a single Voted Answer (ElGamal Pair).

Ballot Codebooks and Commitments

Definition A-1. A Vote Verification Dictionary, D, is a map from Answer Marks to character strings. This embodiment only considers a special subset of Vote Verification Dictionaries, namely the parameterized family of maps
D_{α}(A)=H(γ_{A}^{α}) (A-1)
where H is a publicly known “shortening function”. (One can think of H as simply truncation to a fixed length.) For practical reasons, H should also have the property that the probability over α of H(γ_{A}^{α})=H(γ_{B}^{α}) for A≠B is small. This property can be assured for any reasonable H simply by making the length of its output sufficiently long—20 bits should be more than sufficient. (This restriction can be eliminated entirely by explicitly sorting the values of (γ_{A}^{α}) for each fixed question. In this embodiment, instead take D₆₀ (A) to be the index of (γ_{A}^{α}) in the set of all (γ_{A′}^{α}), where A′ ranges over all allowed answers to A s ballot question. The verification steps required in tabulation, T.2 below can then be augmented in a manner that should be clear to one skilled in the art.)

Definition A-2. A Dictionary Commitment, C, is an element of the Election Encoding Subgroup.

Clearly there is a unique, publicly verifiable correspondence between Dictionary Commitments and Vote Verification Dictionaries, namely
CD_{log}_{_{g}}_{C} (A-2)
However, α=log_{g} C is protected cryptographically even if C is known. This affords the possibility of creating Dictionary Commitments through a multi-authority secret sharing process. If
C=C₁ . . . Cₙ (A-3)
and each Cᵢ=gᵢ^{α} is constructed by a separate Vote Verification Trustee, then

$$α \dot{=} {log}_{g} C = {\sum }_{i = 1}^{n} {log}_{g} {C}_{i} \qquad ( A \text{-} 4 )$$

and α is kept secret unless all n Vote Verification Trustees share their secret αᵢ.

The Election Protocol

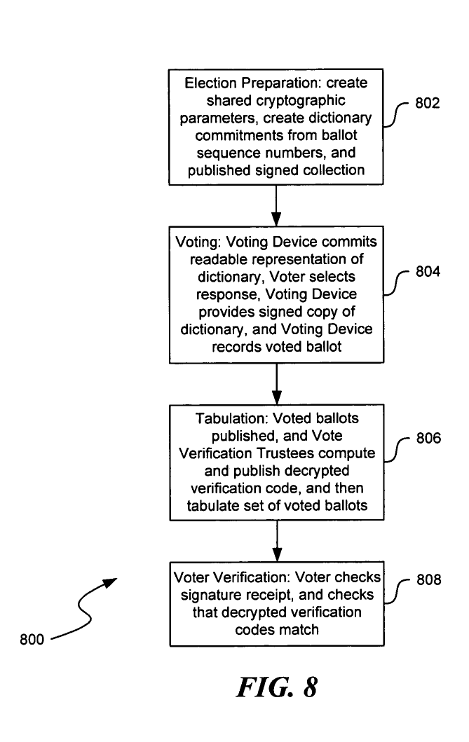

The open count election methodology consists of the following steps, shown in FIG. 8 as a process 800:

Election Preparation (block 802)
EP.1. Shared election cryptographic parameters are created, such as is described in R. Cramer, R. Gennaro, B. Schoenmakers. A secure and optimally efficient multi-authority election scheme. Advances in Cryptology—EUROCRYPT '97, Lecture Notes in Computer Science, Springer-Verlag, 1997.
EP.2. The n Vote Verification Trustees agree on a collection of N_{V} Ballot Sequence Numbers, {bᵢ}ᵢ₌₁^{N}^{_{V}}. (N_{V} must be larger than the number of eligible voters.) A Ballot Sequence Number is simply a ballot identification string that should unique within any one voting “precinct.” (The term precinct is generally used to describe a collection of ballots that will all be tallied together. Precinct ballots are not divided into subsets for counting.)
EP.3. Each of the Vote Verification Trustees, Tⱼ, prepares a fixed sequence of Dictionary Commitments, {C(i,j)}, where α(i,j)=log_{g} C(i,j) is randomly generated by Tⱼ and kept secret. Let

$$C ( i ) \dot{=} {\prod }_{j = 1}^{n} C ( i , j )$$
EP.4. The entire collection of C(i,j) is signed and published.

Voting (Block 804)

Each voter executes the following steps
V.1. The voting device commits a readable representation, D₀, of D₍ᵢ₎. Failure to do so is immediately detectable by voter, so one may henceforth disregard this condition.
   For example, this can be done by paper printout, but other options are available.
   If, by chance, D(A)=D(B) for some A#B, the voter may demand a new Ballot Sequence Number. (By choice of H, this happens with negligible frequency.)
   Procedurally, the voter should be prevented from leaving the poll booth with D.
V.2. Voter selects a response, R, from the available answers.
V.3. The vote device provides a signed copy of D(R) (the vote receipt, or Vote Verification Statement) to the voter. Failure to do so is immediately detectable by the voter, so one can disregard this condition.
V.4. The vote device records the Voted Ballot corresponding to YR. In this simplified election model, this is essentially the ElGamal pair (X,Y) where X=g^{σ}, Y=h^{σ}γ_{R} and σ∈Z_{q} is randomly chosen. (It is also possible to generate σ by way of a secret sharing scheme similar to the way that the Election Private Key, s=log_{g}h, is generated (See, T. Pedersen. A Threshold Cryptosystem Without a Trusted Party, Advances in Cryptology—EUROCRYPT '91, Lecture Notes in Computer Science, pp. 522-526, Springer-Verlag, 1991). The details of this modification should be obvious to one skilled in the art.) In addition, the vote device must also attach a validity proof demonstrating that this is an encryption of at least one of the possible γ_{A}. (Examples of such proofs can be found in, e.g., R. Cramer, I. Damgard, B. Schönmakers. Proofs of partial knowledge and simplified design of witness hiding protocols. Advances in Cryptology—CRYPTO '94, Lecture Notes in Computer Science, pp. 174-187, Springer-Verlag, Berlin, 1994, and R. Cramer, R. Gennaro, B. Schoenmakers. A secure and optimally efficient multi-authority election scheme. Advances in Cryptology—EUROCRYPT '97, Lecture Notes in Computer Science, Springer-Verlag, 1997.)

Tabulation (Block 806)
T.1. The entire list of Voted Ballots is published with associated validity proof created by the vote device(s).
T.2. For each posted Voted Ballot, the Vote Verification Trustees cooperate to verifiably compute, and publish, a Decrypted Verification Code, D₁. This is accomplished by
1. Vote Verification Trustee j computes
   (Xⱼ,Yⱼ)=(X^{α}^{ᵢ},Y^{α}^{ᵢ}) (A-5)
2. Vote Verification Trustee j publishes (Xⱼ,Yⱼ) with a corresponding pair of Chaum-Pedersen proofs (see, e.g., D. Chaum and T. P. Pedersen. Wallet Databases with Observers. Advances in Cryptology—CRYPTO '92, volume 740 of Lecture Notes in Compute Science, pages 89-105, Berlin, 1993. Springer-Verlag), demonstrating that equation A-5 holds.
3. The Vote Verification Trustees cooperate (See, e.g., T. Pedersen. A Threshold Cryptosystem Without a Trusted Party, Advances in Cryptology—EUROCRYPT '91, Lecture Notes in Computer Science, pp. 522-526, Springer-Verlag, 1991.) to decrypt the pair

$$( \overline{X} , \overline{Y} ) \dot{=} ( {\prod }_{j = 1}^{n} {X}_{j} , {\prod }_{j = 1}^{n} {Y}_{j} ) \qquad ( A \text{-} 6 )$$
They publish the decryption, γ, along with decryption validity proofs exactly as in R. Cramer, R. Gennaro, B. Schoenmakers. A Secure and Optimally Efficient Multi-authority Election Scheme. Advances in Cryptology—EUROCRYPT '97, Lecture Notes in Computer Science, Springer-Verlag, 1997. (From this anyone can derive D₁=H(γ). That is, D₁ is effectively published by publishing γ.)
T.3. The Vote Verification Trustees tabulate the entire set of Voted Ballots by way of a verifiable mix (shuffle), and publish the entire mix transcript. (See C. A. Neff, A Verifiable Secret Shuffle and its Application to E-Voting. Proceedings ACM-CCS 2001, 116-125, 2001, and C. A. Neff, Verifiable Secret Shuffles and Their Application to Electronic Voting. U.S. patent application Ser. No. 10/484,931, Jan. 22, 2004.)

Voter Verification (Block 808)

Voters protect the contribution of their response (ballot choice) by
C.1. Immediately checking the receipt signature to be sure that they leave the poll site with indisputable evidence of their Decrypted Verification Code, D₀.
C.2. Check that the published Decrypted Verification Code, D₁ is exactly the same as D₀.

Protocol Consequences

Let A be the voter's intended choice, (\overline{A}) be the choice that is actually encrypted by the vote device, D_{PS} be the Vote Verification Dictionary displayed to the voter in the poll site, C=C₁ . . . Cₙ be the voter's published Dictionary Commitment (referenced by Ballot Sequence Number), D_{C} the Vote Verification Dictionary corresponding to C via equation A-1, D₀, D₁ the two Decrypted Verification Codes described in the protocol, and let δ_{T} be the influence of the voter's published Voted Ballot on the final tally.
Consistency of the relationship
   D_{PS}(A) [symbol] D₀ (A-7)
is protected by voter inspection at vote time.
Consistency (equality) of the relationship
   D₀D₁ (A-8)
is protected by voter inspection of the published tabulation transcript.
Consistency of the relationship
   D₁D_{C}(\overline{A}) (A-9)
is protected by public inspection of the validity proofs in step T.2.
Consistency of the relationship
   \overline{A}δ_{T} (A-10)
is protected by the verifiable mix transcript.

If D_{C}=D_{PS}, then equations A-7-A-9 imply A=\overline{A}. Equation A-10 then implies
A [symbol] δ_{T} (A-11)

In words, the voter's intent has been tabulated correctly.

Protecting the Poll Site Codebook

The conclusion of the previous section was that preservation of voter intent is ultimately reduced to assuring that
D_{C}=D_{PS} (A-12)

To prevent the threat of coercion however, the contents of DC must be kept secret outside of the voter's poll booth experience.

The dilemma is resolved by employing a cut-and-choose approach, specifically, allowing voters, or special observers simulating voters, to verify a D committed by the vote device without using it to vote. In election language, they may “spoil” a ballot in order to check the correctness of its codebook as displayed by the voting device. As long as audits are indistinguishable from actual voters up until the point that the poll site codebook is committed by the device, the accuracy of all poll site Vote Verification Dictionaries can be assured to a high level of confidence.

Observers may easily check equation A-12 for a given Ballot Sequence Number by demanding that the Vote Verification Trustees all reveal their corresponding secrets. Conversely, the Vote Verification Trustees can each ensure that no Voted Ballot corresponding to an audited Ballot Sequence Number is included in the final tally.

Under the scheme above, multiple independent election Authorities, or Trustees must construct, in advance of the election, a collection of voter dictionaries that map voter choices to random strings in a publicly verifiable way. Coordinating the actions of the Authorities, which includes publishing their dictionary share commitments, is a logistical challenge. In addition, each voter's dictionary must be visible to the voter while in the poll booth independent of the voting device, which likely requires the dictionary to be printed in advance, but voters can not be allowed to take an “authentic looking” dictionary with them out of the poll booth (or at least the poll site), otherwise the scheme is vulnerable to vote coercion, or vote buying. This threat can be well countered by employing a printing device that has some simple physical security mechanisms. To ensure that all vote dictionaries presented to voters are authentic, an additional audit step should be introduced wherein some statistically significant number of randomly selected dictionaries are compared against their corresponding dictionary share commitments by requiring the Authorities to “open” (i.e. “reveal”) those commitments. This audit step can be seen as simply part of the voter's check of vote receipt data against the election tally, and hence a relatively light addition to the voting process. (For example, each voter can be presented two dictionaries, and asked to chose at random which one to take for audit, and which to use in the process of voting. Since the “audit” dictionary is compared against public tabulation, it is accurate to call it “one half” of the voter's vote receipt data. This scheme gives a 1 in 2 detection probability for each voter.)

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments. While aspects of the invention are employed in electronic voting applications, these aspects may be applied to other applications, including any application requiring verifiability of user input with respect to electronic documents or data elements.

All of the above patents and applications and other references, including any that may be listed in accompanying filing papers, are incorporated herein by reference, including U.S. patent application Ser. No. 09/535,927 filed Mar. 24, 2000; Ser. No. 09/816,869 filed Mar. 24, 2001; Ser. No. 09/534,836 filed Mar. 24, 2000; Ser. No. 10/484,931 filed Mar. 25, 2002; Ser. No. 09/989,989 filed Nov. 21, 2001; Ser. No. 10/038,752 filed Dec. 31, 2001; Ser. No. 10/081,863 filed Feb. 20, 2002; Ser. No. 10/367,631 filed Feb. 14, 2003; and Ser. No. 10/718,035 filed Nov. 20, 2003; and 60/542,807, filed Feb. 6, 2004, and international application: PCT/US03/04798 filed Feb. 14, 2003. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the library status reporting to the host may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. An automated method for permitting a voter to vote in an election, the method comprising:
providing to the voter an electronic ballot, wherein the electronic ballot includes at least two ballot choices;
receiving from the voter a selected ballot choice;
automatically generating a verifiable choice associated with the selected ballot choice, wherein the verifiable choice represents a matrix having at least a two dimensional array of positions, wherein the matrix includes at least two rows or columns along one axis associated with the at least two ballot choices, and a predetermined number of columns or rows in a transverse axis, and wherein each of the positions in the two dimensional array of positions is associated with a secret value hidden from the voter;
printing at least one pledge associated with the selected ballot choice;
prompting the voter to select at least one of the predetermined number of columns or rows associated with the transverse axis;
receiving from the voter a selected one of the predetermined number of columns or rows associated with the transverse axis;
revealing to the voter at least one value in the matrix associated with at least one position corresponding to the selected ballot choice along the one axis and the selected one of the predetermined number of columns or rows associated with the transverse axis, wherein the revealed value is associated with the selected ballot choice and is related to the printed pledge to verify to the voter that the verifiable choice is associated with the selected ballot choice; and,
providing the verifiable choice for tally in the election.

2. The method of claim 1 wherein the printing includes printing and obscuring the pledge before receiving from the voter a selected one of the predetermined number of columns or rows associated with the transverse axis.

3. The method of claim 1 wherein the values are binary values, and wherein the selected one of the predetermined number of columns or rows associated with the transverse axis is a predetermined pattern of positions to be revealed.

4. The method of claim 1 wherein automatically generating a verifiable choice associated with the selected ballot choice includes providing a same value for each position in the one axis associated with the selected ballot choice.

5. The method of claim 1 wherein the ballot choices include yes, no, and abstain choices, and wherein the voter's choice is represented by an encoding scheme that differs from an encoding scheme for the voter's unchoices.

6. A computer-readable medium whose contents cause at least one data processing device to perform a method to provide proof of a ballot cast in an electronic election, the method comprising:
receiving an indication corresponding to casting of an electronic ballot to represent an intended choice associated with the cast ballot;
generating a private, paper receipt that represents the intended choice associated with the cast ballot; and
wherein the private, paper receipt includes human-readable information to permit public verification that the cast ballot has been included in a ballot tabulation process, and wherein an ability to discern what the intended choice was with respect to the cast ballot from the human-readable information on the private, paper receipt is restricted.

7. The computer-readable medium of claim 6 wherein the computer-readable medium is a memory for a data processing device.

8. The computer-readable medium of claim 6 wherein the computer-readable medium is a logical node in a computer network receiving the contents.

9. The computer-readable medium of claim 6 wherein the computer-readable medium is a computer-readable disk.

10. The computer-readable medium of claim 6 wherein the computer-readable medium is a data transmission medium carrying a generated data signal containing the contents.

11. The computer-readable medium of claim 6 wherein the generating includes employing error detecting codes to represent with equal parity the intended choice, and to represent with unequal parity any unintended choices.

12. An apparatus for providing electronic voting, comprising:
display means for displaying instructions, information, and ballot choices to a voter;
printer means for producing a voting receipt to the voter; and
voting device means, including user input means, for receiving input from the voter to select at least one of the ballot choices, and wherein the voting device means includes:
means for generating an electronic ballot commitment based on the received ballot choice;
means for producing a pledge commitment based at least in part on the electronic ballot;
means for receiving a challenge from the voter and providing response information; and
means for recording or transmitting an encrypted ballot that at least includes the received ballot choice, and
wherein the printer means produces the voting receipt based on the received ballot choice and provides information to the voter regarding the received ballot choice without providing public information regarding the received ballot choice.

13. The apparatus of claim 12 wherein the means for generating employs cryptographic error detection codes that represent the received ballot choice with one parity, and represent remaining ballot choices with another parity

14. The apparatus of claim 12 wherein the printer means includes an obscuring shield to visually obscure a printed pledge commitment before receiving from the voter the challenge, and wherein the printer means provides the pledge commitment to the voter after receiving the challenge.

15. The apparatus of claim 12 wherein the printer means includes an obscuring shield to visually obscure a printed unlock code before receiving from the voter the challenge, and wherein the display means displays one or more pledge commitments with one or more voter received ballot choices after the voting device means receives the unlock code.

16. The apparatus of claim 12 wherein the printer means includes an obscuring shield to visually obscure at least one printed pledge commitment before receiving from the voter at least one challenge, wherein the printer means provides the pledge commitment to the voter after receiving the challenge, wherein the printer means prints the receipt with ballot choices and associated pledges for comparison by the voter with the printed pledge commitment, and wherein the printer means erases the printed pledge commitment after voter comparison.

17. The apparatus of claim 12 wherein the voting device means includes a one-way communication channel coupled with the printer means for at least selectively only providing data to and not receive data from the printer means, and wherein the printer means, or a separate device, includes user-input means for receiving a voter input code.

18. The apparatus of claim 12 wherein the voting device means is located remote from a voting poll location, and wherein the voting device means is at least selectively coupled to a computer network.

19. The apparatus of claim 12 wherein the pledge commitment is provided to the voter by either the voting device means or by the printer means.

20. An apparatus for use in electronic voting, the apparatus comprising:
a display device for displaying ballot choices to a voter;
a receipt generator for producing a voting receipt to the voter based on the voter's selection of at least one of the ballot choices;
a voting device having a user input portion to receive the voter's selection of the ballot choices, wherein the voting device is configured to create an encrypted electronic ballot based on the voter selected ballot choices; and
a one-way communication channel coupled among the receipt generator and the voting device, wherein the one-way communication channel at least selectively permits the voting device to provide information to the receipt generator to permit the receipt generator to produce the voting receipt for the voter.

21. The apparatus of claim 20 wherein the one-way communication channel includes: an wireless transmitter coupled to the voting device, and a wireless receiver coupled to the receipt generator and configured to receive communications from the wireless transmitter; a removable storage media writer coupled to the voting device and a removable storage media reader coupled to the receipt generator to permit the voter to move a piece of storage media from the removable storage media writer to the removable storage media reader; or an intermediate switch box for selective connecting and disconnecting the voting device to the receipt generator.

22. The apparatus of claim 20 wherein the one-way communication channel or the receipt generator includes a user input device to receive voter input at least at a time when the voting device can not receive data from the receipt generator.

23. A machine-readable medium storing a data structure, wherein the data structure is configured for encoding user selected choices associated with the data structure, the data structure comprising:
first and second code words, wherein the first code word corresponds to a user-selected choice and the second code word corresponds to at least one choice not selected by the user;
an encryption function for encrypting the first and second code words;
a partial reveal function for both generating encrypted data for output, and for generating an output parameter regarding the encrypted first and second code words and the user-selected choice; and,
a relationship operation between the first and second code words and the partial reveal function, wherein the relationship operation is capable of being automatically implemented, and wherein the relationship operation permits a receipt to be generated for the user that represents to the user the user-selected choice, but which does not provide to others information regarding the user-selected choice.

24. The data structure of claim 23 wherein the first and second code words are encoded using odd and even parity encoding pairs, or using orthogonal group encoding.

25. A method for providing proof of a ballot cast in an election, the method comprising:
casting a ballot representing a voter's intended choice associated with a cast ballot;
creating a private, paper receipt that represents the voter's intended choice associated with the cast ballot; and
wherein the private, paper receipt includes human-readable information to permit the voter to publicly verify that the cast ballot has been included in a ballot tabulation process, and wherein only the voter can discern from the human-readable information on the private, paper receipt what the voter's intended choice was, with respect to the cast ballot.

26. The method of claim 25, further comprising generating, from multiple election authorities, symmetric shares of verifiable choices for use in casting the ballot.

27. The method of claim 25, further comprising generating, from multiple election authorities, multiple challenge strings or challenge string shares for use by voters to verify intended choices with respect to cast ballots.

28. An electronic voting method, comprising:
establishing election parameters, including generating by multiple election authorities secret dictionaries based on ballot sequence numbers, and publishing a digitally signed collection of secret dictionaries;
at a voting device, committing a representation of at least one of the secret dictionaries to a voter, receiving a voter's input, and providing a signed copy of the at least one dictionary to the voter; and
tabulating published ballots, and publishing a verification code produced by at least some of the election authorities.
